(19) United States
(12) Patent Application Publication
(10) Pub. No.: US 2016/0149618 A1
(43) Pub. Date: May 26, 2016

(54) SERVICE REACQUISITION

(71) Applicant: QUALCOMM Incorporated, San Diego, CA (US)

(72) Inventors: Bhaskara Viswanadham Batchu, Hyderabad (IN); Pravir Kumar, Purnea (IN); Mihir Nabar, Hyderabad (IN)

(21) Appl. No.: 14/553,820

(22) Filed: Nov. 25, 2014

(51) Int. Cl. H04B 7/04; H04W 48/16; H04W 88/06

(52) U.S. Cl. CPC H04B 7/0404; H04W 88/06; H04W 48/16

(57) ABSTRACT

Systems, methods, apparatuses, and media are provided for use of multi-RAT user equipment. Communication may be performed using a first radio access technology on a first transceiver. A diversity receiver may be used to provide spatial diversity for the communication using the first radio access technology. Use of the diversity receiver to provide spatial diversity for the communication using the first radio access technology may be stopped. Use of the diversity receiver to communicate using a second radio access technology may be started, with the communication using the first radio access technology continuing on the first transceiver.

### BACKGROUND

1. Field

Embodiments described herein generally relate to use of user equipment RF chains to allow improved communication on multiple radio access technologies.

2. Background

A user equipment (“UE”), such as a mobile phone device, may be enabled for one or more radio access technologies (“RATs”), such as Frequency Division Multiple Access (FDMA), Time Division Multiple Access (TDMA), Code Division Multiple Access (CDMA), Universal Mobile Telecommunications Systems (UMTS) (particularly, Long Term Evolution (LTE)), Global System for Mobile Communications (GSM), Wi-Fi, PCS, or other protocols that may be used in a wireless communications network or a data communications network. One or more RATs may be enabled by one, or a plurality of subscriber identity modules (“SIMs”). For example, a UE may be a multi-SIM UE, where each of a plurality of SIMs received or otherwise coupled to the multi-SIM UE may support one or more RATs.

### SUMMARY

Various embodiments relate to use of user equipment RF chains to allow improved communication on multiple radio access technologies.

According to some embodiments, a method is provided. The method includes communicating using a first radio access technology on a first transceiver. The method further includes using a diversity receiver to provide spatial diversity for the communication using the first radio access technology. The method further includes stopping the use of the diversity receiver to provide spatial diversity for the communication using the first radio access technology. The method further includes starting use of the diversity receiver to communicate using a second radio access technology, with the communication using the first radio access technology continuing on the first transceiver.

In some embodiments, stopping the use of the diversity receiver to provide spatial diversity for the communication using the first radio access technology is performed at a first time. In such embodiments, starting the use of the diversity receiver to communicate using a second radio access technology is performed at or after the first time.

In some embodiments, the method further includes stopping the use of the diversity receiver to communicate using the second radio access technology. In such embodiments, the method further includes resuming the use of the diversity receiver to provide spatial diversity for the communication using the first radio access technology.

In some embodiments, stopping the use of the diversity receiver to communicate using the second radio access technology is performed at a second time. In such embodiments, resuming the use of the diversity receiver to provide spatial diversity for the communication using the first radio access technology is performed at or after the second time.

In some embodiments, stopping the use of the diversity receiver to provide spatial diversity for the communication using the first radio access technology is performed at a first time. In such embodiments, starting the use of the diversity receiver to communicate using a second radio access technology is performed at or after the first time. In such embodiments, stopping the use of the diversity receiver to communicate using the second radio access technology is performed at a second time. In such embodiments, resuming the use of the diversity receiver to provide spatial diversity for the communication using the first radio access technology is performed at or after the second time.

In some embodiments, the first time occurs before the second time. In such embodiments, the communication using the first radio access technology continues on the first transceiver from the first time to the second time.

In some embodiments, first radio access technology is different from the second radio access technology.

In some embodiments, the method further includes determining when to perform start of the use of the diversity receiver to communicate using the second radio access technology based on an expected availability of a shared modem resource that is shared between the first transceiver and a second transceiver.

In some embodiments, the expected availability of the shared modem resource is based on communication using a third radio access technology on the second transceiver.

In some embodiments, the communication using the third radio access technology on the second transceiver is a paging interval for the third radio access technology.

In some embodiments, the paging interval for the third radio access technology occurs between periods of communication using a fourth radio access technology on the second transceiver.

In some embodiments, the use of the diversity receiver to communicate using the second radio access technology includes performing a public land mobile network (PLMN) search for the second radio access technology.

In some embodiments, the method further includes performing a shortened reacquisition procedure for the second radio access technology on the first transceiver.

In some embodiments, the shortened reacquisition procedure is shorter than a standard reacquisition procedure based on a processing performed as part of the use of the diversity receiver to communicate using the second radio access technology.

In some embodiments, the processing performed as part of the use of the diversity receiver to communicate using the second radio access technology includes a public land mobile network (PLMN) search for the second radio access technology.

In some embodiments, the method further includes skipping a public land mobile network (PLMN) search as part of a reacquisition process for the second radio access technology on the first transceiver performed after termination of the communication using the first radio access technology on the first transceiver.

In some embodiments, the method further includes performing a PLMN search for the second radio access technology as part of the use of the diversity receiver to provide communication using the second radio access technology.

In some embodiments, the method further includes using results of the PLMN search for the second radio access technology performed as part of the use of the diversity receiver to provide communication using the second radio access technology as part of the reacquisition process for the second radio access technology on the first transceiver.

In some embodiments, the method further includes communicating using the second radio access technology on the first transceiver prior to communicating using the first radio access technology on the first transceiver. In such embodiments, the method further includes suspending the communication using the second radio access technology on the first transceiver in order to allow the communication using the first radio access technology on the first transceiver.

According to some embodiments, a user equipment (UE) apparatus is provided. The UE apparatus includes a first transceiver configured to communicate using a first radio access technology. The UE apparatus includes a diversity receiver configured to provide spatial diversity for the communication using the first radio access technology. The diversity receiver is configured to stop the providing of spatial diversity for the communication using the first radio access technology. The diversity receiver is configured to start communication using a second radio access technology, with the communication using the first radio access technology continuing on the first transceiver.

In some embodiments, the first radio access technology is different from the second radio access technology.

In some embodiments, the UE apparatus further includes a processor configured to determine when the diversity receiver will start communication using the second radio access technology based on an expected availability of a shared modem resource that is shared between the first transceiver and a second transceiver.

In some embodiments, the diversity receiver is configured to perform a public land mobile access network (PLMN) search for the second radio access technology as part of the communication using the second radio access technology.

In some embodiments, the first transceiver is configured to perform a shortened reacquisition for the second radio access technology.

In some embodiments, the shortened reacquisition procedure is shorter than a standard reacquisition procedure based on a processing performed by the diversity receiver as part of the communication using the second radio access technology.

In some embodiments, the processing performed by the diversity receiver as part of the communication using the second radio access technology includes a public land mobile network (PLMN) search for the second radio access technology.

In some embodiments, the first transceiver is configured to skip a public land mobile network (PLMN) search as part of a reacquisition process for the second radio access technology after termination of the communication by the first transceiver using the first radio access technology.

According to some embodiments, a non-transitory computer-readable medium is provided. The medium includes instructions configured to cause one or more computing devices to communicate using a first radio access technology on a first transceiver. The medium includes instructions configured to cause one or more computing devices to use a diversity receiver to provide spatial diversity for the communication using the first radio access technology. The medium includes instructions configured to cause one or more computing devices to stop the use of the diversity receiver to provide spatial diversity for the communication using the first radio access technology. The medium includes instructions configured to cause one or more computing devices to start use of the diversity receiver to communicate using a second radio access technology, with the communication using the first radio access technology continuing on the first transceiver.

According to some embodiments, a user equipment (UE) apparatus is provided. The UE apparatus includes means for communicating using a first radio access technology on a first transceiver. The UE apparatus includes means for using a diversity receiver to provide spatial diversity for the communication using the first radio access technology. The UE apparatus includes means for stopping the use of the diversity receiver to provide spatial diversity for the communication using the first radio access technology. The UE apparatus includes means for starting use of the diversity receiver to communicate using a second radio access technology, with the communication using the first radio access technology continuing on the first transceiver.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the various embodiments.

FIG. 1 is a schematic diagram illustrating an example of a system according to various embodiments.

FIG. 2 is a functional block diagram illustrating an example of a user equipment according to various embodiments.

FIG. 3A is a schematic diagram illustrating an example of a user equipment according to various embodiments.

FIG. 3B is a schematic diagram illustrating an example of a user equipment according to various embodiments.

FIG. 4A is a schematic diagram illustrating an example of a user equipment according to various embodiments.

FIG. 4B is a schematic diagram illustrating an example of a user equipment according to various embodiments.

FIG. 4C is a schematic diagram illustrating an example of a user equipment according to various embodiments.

FIG. 5A is a schematic diagram illustrating a communication sequence according to various embodiments.

FIG. 5B is a schematic diagram illustrating a communication sequence according to various embodiments.

FIG. 6A is a schematic diagram illustrating a communication sequence according to various embodiments.

FIG. 6B is a schematic diagram illustrating a communication sequence according to various embodiments.

FIG. 7A is a schematic diagram illustrating a communication sequence according to various embodiments.

FIG. 7B is a schematic diagram illustrating a communication sequence according to various embodiments.

FIG. 8 is a flowchart of a process according to various embodiments.

FIG. 9 is a flowchart of a process according to various embodiments.

FIG. 10A is a flowchart of a process according to various embodiments.

FIG. 10B is a flowchart of a process according to various embodiments.

FIG. 11 is a component block diagram of a user equipment suitable for use with various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the invention or the claim.

Various modern communication devices are described herein. Such a modern communication device may be referred to herein as a user equipment (“UE”). However, such a modern communication device may also be referred to as a mobile station (“MS”), a wireless device, a communications device, a wireless communications device, a mobile device, a mobile phone, a mobile telephone, a cellular device, a cellular telephone, and in other ways. Examples of UE include, but are not limited to, mobile phones, laptop computers, smart phones, and other mobile communication devices of the like that are configured to connect to one or more RATs.

Some UE may contain one or more subscriber identity modules (“SIMs”) that provide users of the UEs with access to one or multiple separate mobile networks, supported by radio access technologies (“RATs”). Examples of RATs may include, but are not limited to, Global Standard for Mobile (“GSM”), Code Division Multiple Access (“CDMA”), CDMA2000, Time Division-Code Division Multiple Access (“TD-CDMA”), Time Division-Synchronous Code Division Multiple Access (“TD-SCDMA”), Wideband-Code Division Multiple Access (“W-CDMA”), Time Division Multiple Access (“TDMA”), Frequency Division Multiple Access (“FDMA”), Long-Term Evolution (“LTE”), wireless fidelity (“Wi-Fi”), various 3G standards, various 4G standards, and the like.

Embodiments described herein relate to both single-SIM and multi-SIM UEs. A UE that includes a plurality of SIMs and connects to two or more separate RATs using a same set of RF resources (e.g., radio-frequency (“RF”) transceivers) is a multi-SIM-multi-standby (“MSMS”) communication device. In one example, the MSMS communication device may be a dual-SIM-dual-standby (“DSDS”) communication device, which may include two SIM cards/subscriptions that may both be active on standby, but one is deactivated when the other one is in use. In another example, the MSMS communication device may be a triple-SIM-triple-standby (“TSTS”) communication device, which includes three SIM cards/subscriptions that may all be active on standby, where two may be deactivated when the third one is in use. In other examples, the MSMS communication device may be other suitable multi-SIM communication devices, with, for example, four or more SIMs, such that when one is in use, the others may be deactivated.

Further, a UE that includes a plurality of SIMs and connects to two or more separate mobile networks using two or more separate sets of RF resources is termed a multi-SIM-multi-active (“MSMA”) communication device. An example MSMA communication device is a dual-SIM-dual-active (“DSDA”) communication device, which includes two SIM cards/subscriptions, each associated with a separate RAT, where both SIMs may remain active at any given time. In another example, the MSMA device may be a triple-SIM-triple-active (“TSTA”) communication device, which includes three SIM cards/subscriptions, each associated with a separate RAT, where all three SIMs may remain active at any given time. In other examples, the MSMA communication device may be other suitable multi-SIM communication devices, with, for example, four or more SIMs, such that all SIMs are active at any given time.

In addition, a plurality of modes are enabled by one SIM, such that each mode may correspond to a separate RAT. Such a SIM is a multi-mode SIM. A UE may include one or more multi-mode SIMs. The UE may be a MSMS communication device (such as, but not limited to, a DSDS or a TSTS communication device), a MSMA communication device (e.g., a DSDA, TSTA communication device, or the like), or a multi-mode device.

As used herein, UE refers to one of a cellular telephone, smart phone, personal or mobile multi-media player, personal data assistant, laptop computer, personal computers, tablet computer, smart book, palm-top computer, wireless electronic mail receiver, multimedia Internet-enabled cellular telephone, wireless gaming controller, and similar personal electronic device that include one or more SIMs, a programmable processor, memory, and circuitry for connecting to one or more mobile communication networks (simultaneously or sequentially). Various embodiments may be useful in mobile communication devices, such as smart phones, and such devices are referred to in the descriptions of various embodiments. However, the embodiments may be useful in any electronic device, such as a DSDS, a TSTS, a DSDA, a TSTA communication device (or other suitable multi-SIM, multi-mode devices), that may individually maintain one or more subscriptions that utilize one or a plurality of separate set of RF resources.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the UE to establish a communication link for a particular communication service with a particular network, the term “SIM” may also be used herein as a shorthand reference to the communication service associated with and enabled by the information (e.g., in the form of various parameters) stored in a particular SIM as the SIM and the communication network, as well as the services and subscriptions supported by that network, correlate to one another.

Embodiments described herein are directed to use of user equipment RF chains to allow improved communication on multiple radio access technologies. While a UE that support multiple RATs may be provided with one or more transceivers, such a UE may still be unable to support full simultaneous use of all supported RATs at the same time. Because of this, one RAT may be suspended, idled, or otherwise prevented from actively communicating due to another RAT using a shared transceiver or some other shared resource. Unfortunately, while the RAT is suspended or otherwise not active, the UE may lose connection to the network with which the UE was previously communicating. This could be due to movement of the UE during the traffic suspended state, wherein the UE moves to an area without coverage for the previously connected network. As a result, when traffic is resumed on the suspended RAT, a lengthy reacquisition of a connection may be required, such as first performing a network search and then performing a registration sequence for one or more of the discovered networks.

Accordingly, various embodiments are directed to techniques for more rapidly reacquiring a network connection after traffic has moved to a suspended state on a (second) RAT due to use of a shared resource by a (first) RAT. In some embodiments, the first RAT may make use of a shared transceiver for active communications. A diversity receiver may be present on the UE for use in various ways. The diversity receiver may be used to provide additional spatial diversity on the downlink for the first RAT using the shared transceiver. For example, the diversity receiver may be used to receive Global Positioning System (GPS) signals. Regardless of the ordinary purpose of the diversity receiver, embodiments allow temporary use of the diversity receiver for communications by the second RAT. In particular, some activities, such as a network search, that would generally need to be performed after resumption of communications on the second RAT as part of a reacquisition process can be performed even before the first RAT has terminated communication using the shared transceiver. For example, the diversity receiver can be periodically used to receive signals for the second RAT that can then be processed in order to determine what Public Land Mobile Networks (PLMNs) are available in the area. In this way, when the first RAT terminates communication on the shared transceiver and the second RAT resumes communication on the shared transceiver, the PLMN search portion of the reacquisition process may be skipped. In some embodiments, the use of the diversity receiver for the second RAT may be further coordinated with a third, fourth, or more RATs based on other shared resources. For example, use of the diversity receiver for the second RAT may be coordinated with paging intervals for a third RAT that are interspersed in communications using a fourth RAT, both on another shared transceiver.

Based on the various embodiments described herein, numerous benefits can be achieved. First, the embodiments may allow for more efficient use of resources contained in the UE. Based on the coordinating of use of the diversity receiver with one or more other RATs, the diversity receiver, a backend demodulator, and other shared resources may be used more effectively and with less downtime than would otherwise be possible. Second, the embodiments may allow a more rapid return to active communications for the second RAT after termination of communication using the first RAT on the shared transceiver. As a result, a user of the UE may be more satisfied due to less latency in resuming communication with the second RAT. Third, the embodiments may allow the second RAT communications without any period of complete loss of signal for the first RAT. In particular, it may be that only the diversity receiver is taken away from the first RAT communications in order to perform the techniques described herein. This may allow the first RAT to have continuous and uninterrupted use of both the receiver and transmitter of the shared transceiver, so that there are no intermittent periods of signal loss that would otherwise be caused by intermittent use of the shared transceiver for the second RAT communications. Various other benefits may result based on the embodiments disclosed herein.

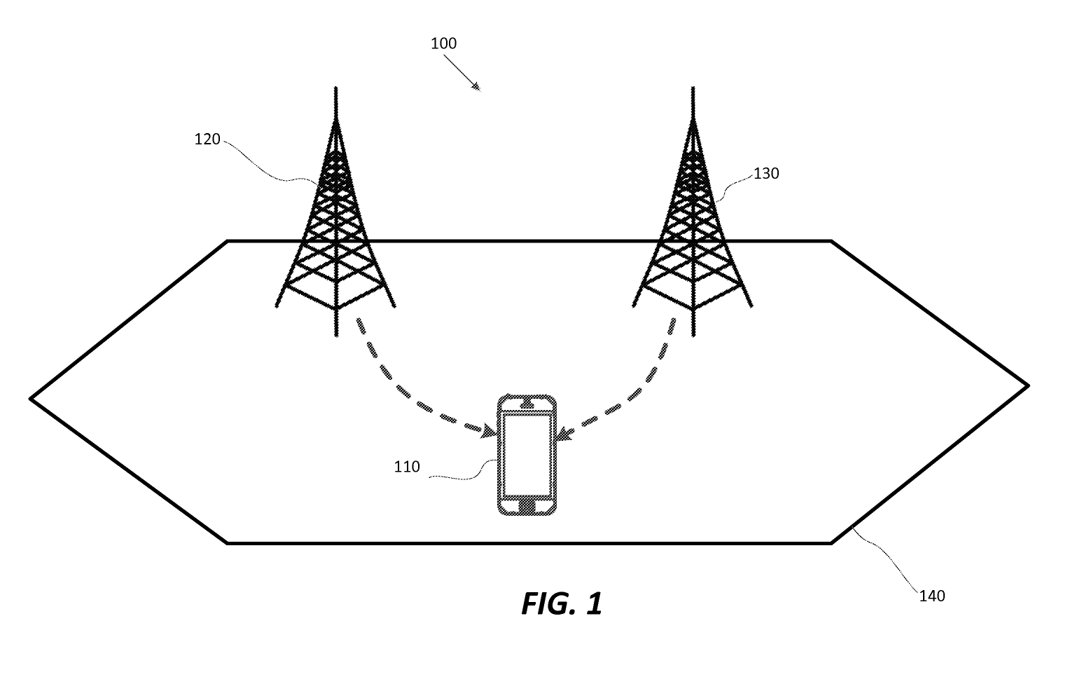

With reference to FIG. 1, a schematic diagram of a system 100 is shown in accordance with various embodiments. The system 100 may include a UE 110, a first base station 120, and a second base station 130. In some embodiments, each of the first base station 120 and the second base station 130 may represent a separate RAT, such as GSM, CDMA, CDMA2000, TD-CDMA, TD-SCDMA, W-CDMA, TDMA, FDMA, LTE, WiFi, various 3G standards, various 4G standards, and/or the like. In other words, the first base station 120 may represent a first RAT, and the second base station may represent a second RAT, where the first RAT and the second RAT are different RATs. By way of illustrating with a non-limiting example, the first base station 120 may be transmitting W-CDMA while the second base station 130 may be transmitting GSM. In some embodiments, each RAT may be transmitted by the associated base station at different physical locations (i.e., the first base station 120 and the second base station 130 may be at different locations). In other embodiments, each RAT may be transmitted by the associated base station at the same physical location (i.e., the first base station 120 and the second base station 130 may be physically joined, or the base stations are the same base station).

The first base station 120 and the second base station 130 may each include at least one antenna group or transmission station located in the same or different areas, where the at least one antenna group or transmission station may be associated with signal transmission and reception. The first base station 120 and the second base station 130 may each include one or more processors, modulators, multiplexers, demodulators, demultiplexers, antennas, and the like for performing the functions described herein. In some embodiments, the first base station 120 and the second base station 130 may be utilized for communication with the UE 110 and may be an access point, Node B, evolved Node B (eNode B or eNB), base transceiver station (BTS), or the like.

A cell 140 may be an area associated with the first base station 120 and the second base station 130, such that the UE 110, when located within the cell 140, may connect to or otherwise access both the first and second RATs, as supported by the first base station 120 and the second base station 130 (e.g., receive signals from and transmit signals to the first base station 120 and the second base station 130), respectively. The cell 140 may be a defined area, or may refer to an undefined area in which the UE 110 may access the RATs supported by the base stations 120, 130.

In various embodiments, the UE 110 may be configured to access the RATs from the first base station 120 and/or the second base station 130 (e.g., receive/transmit signals of the first and/or the second RAT from/to the first base station 120 and/or the second base station 130). The UE 110 may be configured to access the RATs by virtue of the multi-SIM and/or the multi-mode SIM configuration of the UE 110 as described, such that when a SIM corresponding to a RAT is received, the UE 110 may be allowed to access that RAT, as provided by the associated base station.

In general, an acquisition process of a RAT refers to the process in which the UE 110 searches and acquires various communication protocols of the RAT in order to acquire and establish communication or traffic with the target base node that is broadcasting the RAT. Some communication protocols include synchronization channels, such as, but not limited to, primary synchronization channel (“P-SCH”), secondary synchronization channel (“S-SCH”), common pilot channel (“CPICH”), and the like. The target base nodes are nodes that transmit, broadcast, or otherwise support the particular RAT being acquired. In some embodiments, the first base station 120 may be a target base node for the first RAT, given that the first RAT may be transmitted by the first base station 120 as described. Thus, when the UE 110 initiates an acquisition process of the first RAT (as supported by the first base station 120), a communication channel is set for future communication and traffic between the UE 110 and the first base station 120. Similarly, the second base station 130 may be a target base node for the second RAT, which is transmitted by the second base station 130 as described. Thus, when the UE 110 initiates an acquisition process of the second RAT, a communication channel is set for future communication and traffic between the UE 110 and the second base station 130. The acquisition process may be initiated when the UE 110 seeks to initially access the RAT, or, after attaching to an initial RAT, to identify candidate target RAT (that is not the initial RAT) for a handover.

It should be appreciated by one of ordinary skill in the art that FIG. 1 and its corresponding disclosure are for illustrative purposes, and that the system 100 may include three or more base stations. In some embodiments, three or more base stations may be present, where each of the three or more base stations may represent (i.e., transmits signals for) one or more separate RATs in the manner such as, but not limited to, described herein.

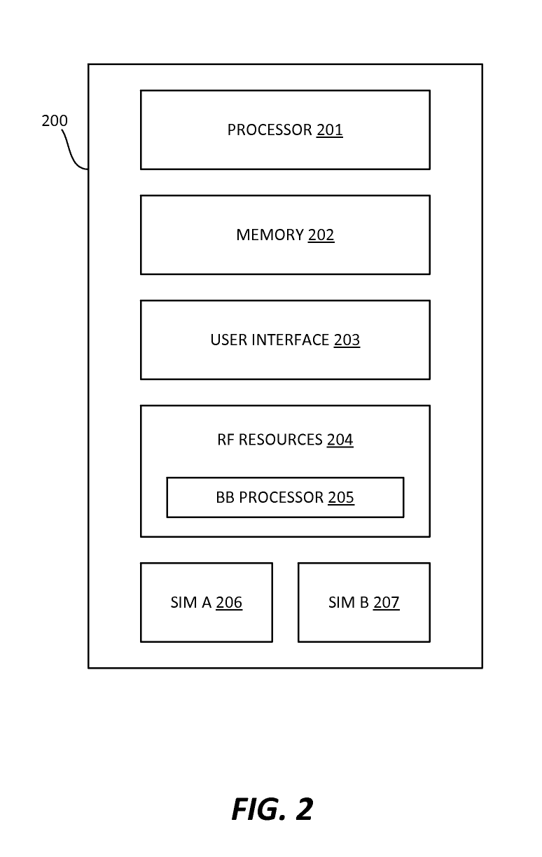

FIG. 2 is a functional block diagram of a UE 200 suitable for implementing various embodiments. According to various embodiments, the UE 200 may be the same or similar to the UE 110 as described with reference to FIG. 1. With reference to FIGS. 1-2, the UE 200 may include at least one processor 201, memory 202 coupled to the processor 201, a user interface 203, RF resources 204, and one or more SIMs (as denoted SIM A 206 and SIM B 207).

The processor 201 may include any suitable data processing device, such as a general-purpose processor (e.g., a microprocessor), but in the alternative, the processor 201 may be any suitable electronic processor, controller, microcontroller, or state machine. The processor 201 may also be implemented as a combination of computing devices (e.g., a combination of a DSP and a microprocessor, a plurality of microprocessors, at least one microprocessor in conjunction with a DSP core, or any other such configuration). The memory 202 may be operatively coupled to the processor 201 and may include any suitable internal or external device for storing software and data for controlling and use by the processor 201 to perform operations and functions described herein, including, but not limited to, random access memory RAM, read only memory ROM, floppy disks, hard disks, dongles or other USB connected memory devices, or the like. The memory 202 may store an operating system (“OS”), as well as user application software and executable instructions. The memory 202 may also store application data, such as an array data structure.

The user interface 203 may include a display and a user input device. In some embodiments, the display may include any suitable device that provides a human-perceptible visible signal, audible signal, tactile signal, or any combination thereof, including, but not limited to a touchscreen, LCD, LED, CRT, plasma, or other suitable display screen, audio speaker or other audio generating device, combinations thereof, and the like. In various embodiments, the user input device may include any suitable device that receives input from the use, the user input device including, but not limited to one or more manual operator (such as, but not limited to a switch, button, touchscreen, knob, slider or the like), microphone, camera, image sensor, and the like.

The processor 201 and the memory 202 may be coupled to the RF resources 204. In some embodiments, the RF resources 204 may be one set of RF resources such that only one RAT may be supported by the set of RF resources at any given time. In other embodiments, the RF resources may be a plurality of sets of RF resources, such that each set may support one RAT at a given time, thus enabling the UE 200 to support multiple RATs simultaneously, (e.g., in a MSMA case). The RF resources 204 may include at least one baseband-RF resource chain (with which each SIM in the UE 200, e.g., the SIM A 206 and the SIM B 207, may be associated). The baseband-RF resource chain may include a baseband modem processor 205, which may perform baseband/modem functions for communications on at least one SIM, and may include one or more amplifiers and radios. In some embodiments, baseband-RF resource chains may share the baseband modem processor 205 (i.e., a single device that performs baseband/modem functions for all SIMs on the UE 200). In other embodiments, each baseband-RF resource chain may include physically or logically separate baseband processors 205.

The RF resources 204 may include transceivers that perform transmit/receive functions for the associated SIM of the UE 200. The RF resources 204 may include separate transmit and receive circuitry, such as a separate transmitter and receiver, or may include a transceiver that combines transmitter and receiver functions. The RF resources 204 may each be coupled to a wireless antenna.

In some embodiments, the processor 201, the memory 202, and the RF resources 204 may be included in the UE 200 as a system-on-chip. In some embodiments, the one or more SIMs (e.g., SIM A 206 and SIM B 207) and their corresponding interfaces may be external to the system-on-chip. Further, various input and output devices may be coupled to components on the system-on-chip, such as interfaces or controllers.

The UE 110 is configured to receive one or more SIMs (e.g., SIM A 206 and SIM B 207), an example of which is described herein. A SIM in various embodiments may be a Universal Integrated Circuit Card (UICC) that is configured with SIM and/or USIM applications, enabling access to various RAT networks as described. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the UE 200, and thus need not be a separate or removable circuit, chip or card.

A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

In some embodiments, the UE 200 may include a first SIM interface (not shown) that may receive a first SIM (e.g., SIM A 206), which may be associated with one or more RATs. In addition, the UE 200 may also include a second SIM interface (not shown) that may receive a second SIM (e.g., SIM B 207), which may be associated with one or more RATs that may be different (or the same in some cases) than the one or more RATs associated with SIM A 206. Each SIM may enable a plurality of RATs by being configured as a multi-mode SIM, as described herein. In some embodiments, a first RAT enabled may be a same or different RAT as a second RAT (e.g., a DSDS device may enable two RATs), where both of them may be GSM, or one of them may be GSM and the other may be W-CDMA. In addition, two RATs (which may be the same or different) may each be associated with a separate subscription, or both of them may be associated with a same subscription. For example, a DSDS device may enable LTE and GSM, where both of the RATs enabled may be associated with a same subscription, or, in other cases, LTE may be associated with a first subscription and GSM may be associated with a second subscription different from the first subscription.

In embodiments in which the UE 200 comprises a smart phone, or the like, the UE 200 may have existing hardware and software for telephone and other typical wireless telephone operations, as well as additional hardware and software for providing functions as described herein. Such existing hardware and software includes, for example, one or more input devices (such as, but not limited to keyboards, buttons, touchscreens, cameras, microphones, environmental parameter or condition sensors), display devices (such as, but not limited to electronic display screens, lamps or other light emitting devices, speakers or other audio output devices), telephone and other network communication electronics and software, processing electronics, electronic storage devices and one or more antennae and receiving electronics for receiving various RATs. In such embodiments, some of that existing electronics hardware and software may also be used in the systems and processes for functions as described herein.

Accordingly, such embodiments can be implemented with minimal additional hardware costs. However, other embodiments relate to systems and process that are implemented with dedicated device hardware (UE 200) specifically configured for performing operations described herein. Hardware and/or software for the functions may be incorporated in the UE 200 during manufacturing, for example, as part of the original equipment manufacturer's (“OEM's”) configuration of the UE 200. In further embodiments, such hardware and/or software may be added to the UE 200, after manufacturing of the UE 200, such as by, but not limited to, installing one or more software applications onto the UE 200.

In some embodiments, the UE 200 may include, among other things, additional SIM(s), SIM interface(s), additional RF resource(s) (i.e., sets of RF resources) associated with the additional SIM(s), and additional antennae for connecting to additional RATs supported by the additional SIMs.

Embodiments may be implemented in a UE that performs tune-away or other similar procedures to support communication with multiple RATs. In particular, embodiments may be implemented in a UE capable of concurrently communicating with more than one RAT on a single RF chain, (i.e., a single receiver/transmitter module). For example, a UE may be configured to communicate with both the AT&T W-CDMA network and the Verizon CDMA2000 network.

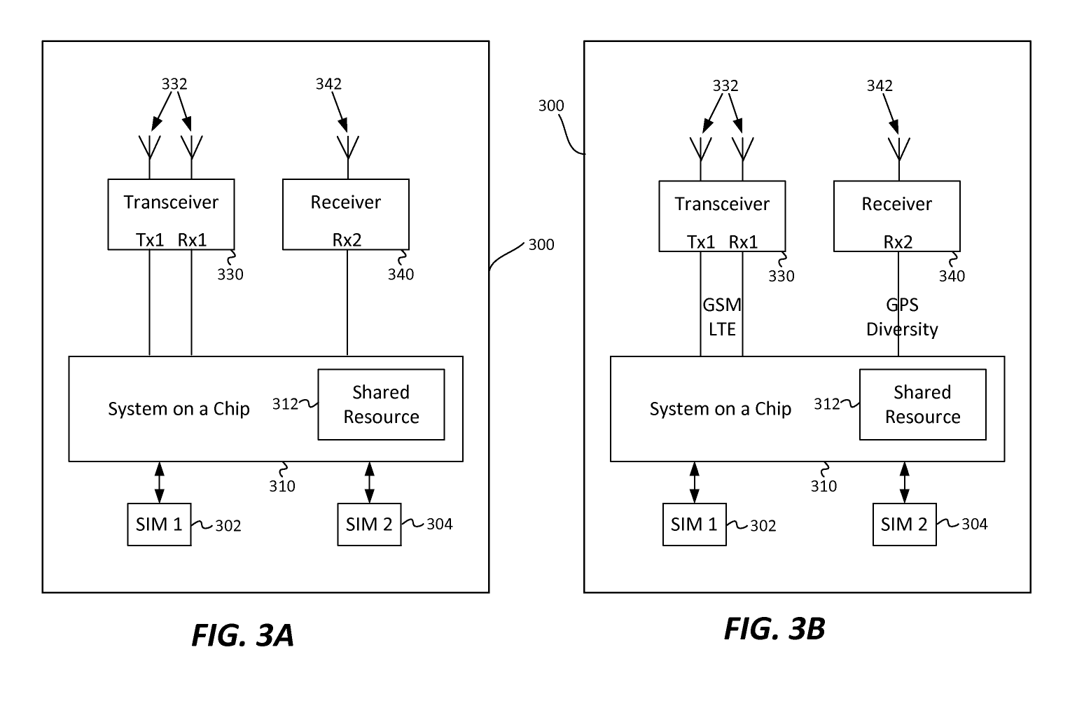

FIG. 3A is a schematic diagram illustrating an example of a UE 300 according to various embodiments. With reference to FIGS. 1-3, the UE 300 may correspond to the UE 110, 200. According to some embodiments, UE 300 may contain: SIM 1 302; SIM 2 304; system on a chip 310; shared resource 312; transceiver 330; receiver 340; and antennas 332 and 342.

In some embodiments, the SIM 1 302 and the SIM 2 304 may be subscriber identity modules that provide subscriptions for multiple RATs. The SIM 1 302 and the SIM 2 304 may be provided similar to the SIM A 206 and the SIM B 207.

In some embodiments, the system on a chip 310 may include various components used for the operation of the UE 300, such as a processor, memory, and some RF resources. The system on a chip 310 may be provided as a combination of the processor 201, the memory 202, and portions of the RF resources 204. With respect to RF resources, the system on a chip 310 may be configured to contain components related to a modem functionality but not components related to transceiver functionality. For example, the system on a chip 310 may contain modulation and demodulation components. According to some embodiments, the system on a chip 310 may have the shared resource 312. The system on a chip 310 may be coupled to the transceiver 330 and the receiver 340. The shared resource 312 may be a component used by more than one of the transceiver 330 and the receiver 340, such as a shared modem resource, thereby being shared between more than one of those components. This configuration may be preferred in order to reduce the size of the system on a chip 310 and/or the cost of producing the system on a chip 310. The system on a chip 310 may contain other shared components other than the shared resource 312.

In some embodiments, the transceiver 330 may include a transmitter Tx1 and receiver Rx1 for communication using more than one RAT. The transceiver 330 may support communication using multiple RATs by, for example, supporting active use of a single RAT at a given time and alternating between active use of the different RATs. The transceiver 330 may use the antennas 332 to perform communication. The antennas 332 may be a MIMO pair of antennas.

In some embodiments, the receiver 340 may include receiver Rx2 for support of receive-only communications using a variety of technologies. The receiver 340 may use the antenna 342 to perform communication. In some embodiments, the receiver 340 may be configured to receive global positioning system (GPS) signals. In some embodiments, the receiver 340 may further be configured to function as a spatial diversity receiver in the downlink for a RAT that is in active communication on the transceiver 330. In such situations, the signals received from Rx2 of the receiver 340 may be combined with the signals received from Rx1 of the transceiver 330 so as to allow a more accurate determination of the transmitted symbol. This use of the receiver 340 for spatial diversity may be especially important in situations where the quality of the communications channel between the UE 300 and the base station (e.g., base station 120) is poor.

While the UE 300 may support alternating use of the transceiver 330 for active communication on a first RAT and a second RAT, the transceiver 330 may not be able to support active communication of both the first RAT and the second RAT at the same time. Therefore, if the first RAT is performing active communication on the transceiver 330, then the second RAT may need to be placed in a traffic suspended state. In some situations, the second RAT may lose its connection with its relevant base station, access point, or other network component due to an extended period of inactivity in the suspended state. In some situations, it may be possible to reduce this problem by periodically performing a tune-away procedure, whereby the transceiver 330 is briefly taken away from its use by the first RAT and instead used by the second RAT. One common approach to the tune-away technique involves periodically using the transceiver 330 to monitor a paging channel for the second RAT even though the first RAT is performing active communication on the transceiver 330.

In some embodiments, a different technique may be used to support suspended state communication for the second RAT while the first RAT is performing active communication on the transceiver 330. In particular, the UE 300 may use the receiver 340 to perform downlink signal reception for the second RAT. This technique may be effective to perform communications such as a public land mobile network (PLMN) search, monitoring of a paging channel, or other downlink reception-only communications. In order to allow this, the UE 300 may have to momentarily take the receiver 340 away from some other existing use, such as reception of GPS signals or use for spatial diversity for the first RAT active communication taking place on the transceiver 330. Nonetheless, this technique has the benefit of still allowing the first RAT to continue active communication on the transceiver 330 without interruption. In this way, the use of the receiver 340 for downlink reception-only communications for the second RAT may be beneficial for not significantly impacting the active communication taking place on the transceiver 330 for the first RAT.

FIG. 3B is a schematic diagram illustrating an example of the UE 300 according to various embodiments. FIG. 3B shows the same components as FIG. 3A, but exemplary RATs are noted for the transceiver 330 and the receiver 340. In particular, in the embodiment of FIG. 3B, the transceiver 330 may support communication using both a GSM RAT and an LTE RAT. As indicated, the receiver 340 may support reception of GPS signals as well as use for spatial diversity to support reception of downlink signals by the transceiver 330.

An exemplary description can be given based on the example RATs noted in FIG. 3B. The GSM RAT may be a first RAT. The LTE RAT may be a second RAT. At some point, the LTE RAT may be performing active communication on the transceiver 330. However, the UE 300 may receive an incoming circuit-switched voice call for the GSM RAT. At this point, the UE 300 may switch the transceiver 330 to provide active communication to the GSM RAT. As such, the LTE RAT may be placed in a traffic suspended state. If the UE 300 moves out of range of the base station through which the UE 300 was connected to an LTE network, then the UE 300 may eventually need to perform a reacquisition process when the GSM voice call ends and the LTE traffic is resumed. However, the reacquisition process can introduce unacceptable latency to such an extent that a user may become aware of the latency and be dissatisfied.

To avoid this issue, the UE 300 may be able to perform some of the reacquisition communications for the LTE RAT before the GSM voice call has terminated. In particular, the UE 300 may periodically use the receiver 340 to receive broadcast signals from base stations of the LTE RAT. These broadcast signals may include PLMN identifiers of the LTE networks to which the base stations belong. This PLMN search or PLMN scan may typically be performed as one of the early steps in the reacquisition process once the GSM voice call ends. Namely, once the GSM voice call ends, the PLMN search may be necessary in order to identify which LTE networks are presently available after the movement of the UE 300. However, because the PLMN search requires only reception of downlink signals (and not transmission of uplink signals), the PLMN search can be performed using the receiver 340 for the LTE RAT even while the GSM RAT is performing active communication on the transceiver 330. Then, when the GSM voice call ends, the UE 300 may perform the reacquisition process for the LTE RAT without having to perform a PLMN search. Namely, though a PLMN search would typically be performed as an early step in reacquisition of the LTE RAT, the PLMN search may be skipped. Instead, the results of a previously performed PLMN search may be used. In particular, the results of the PLMN search most recently performed with the receiver 340 may be used instead of performing a new PLMN search. Thereby, the UE 300 may avoid the delay in time associated with performing the PLMN search. As such, the reacquisition process for the LTE RAT may be considerably shorter, thereby restoring the active LTE communication on the transceiver 330 more rapidly than would otherwise be possible. This may positively impact the user of the UE 300 due to this decrease in latency of resuming LTE communications after termination of the GSM voice call.

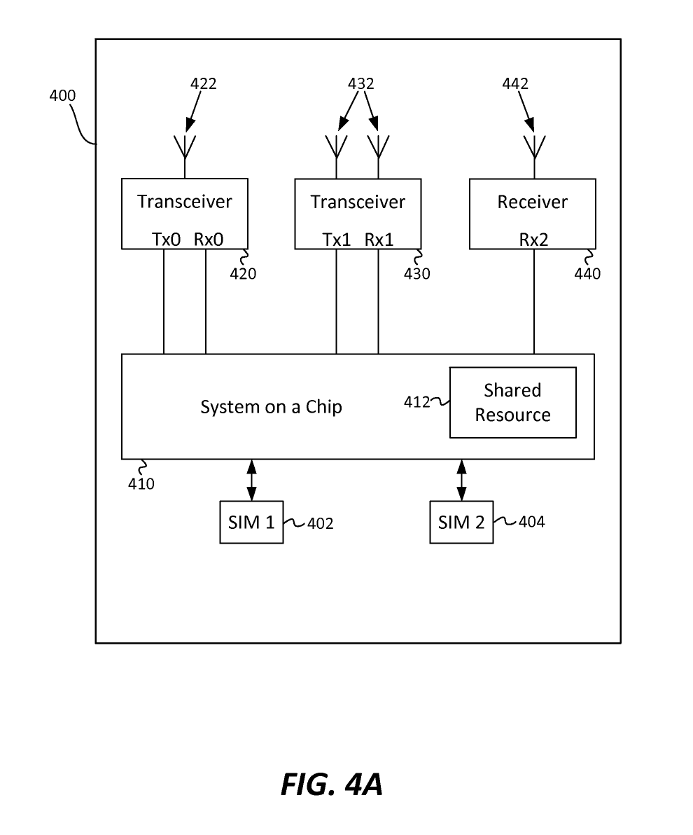

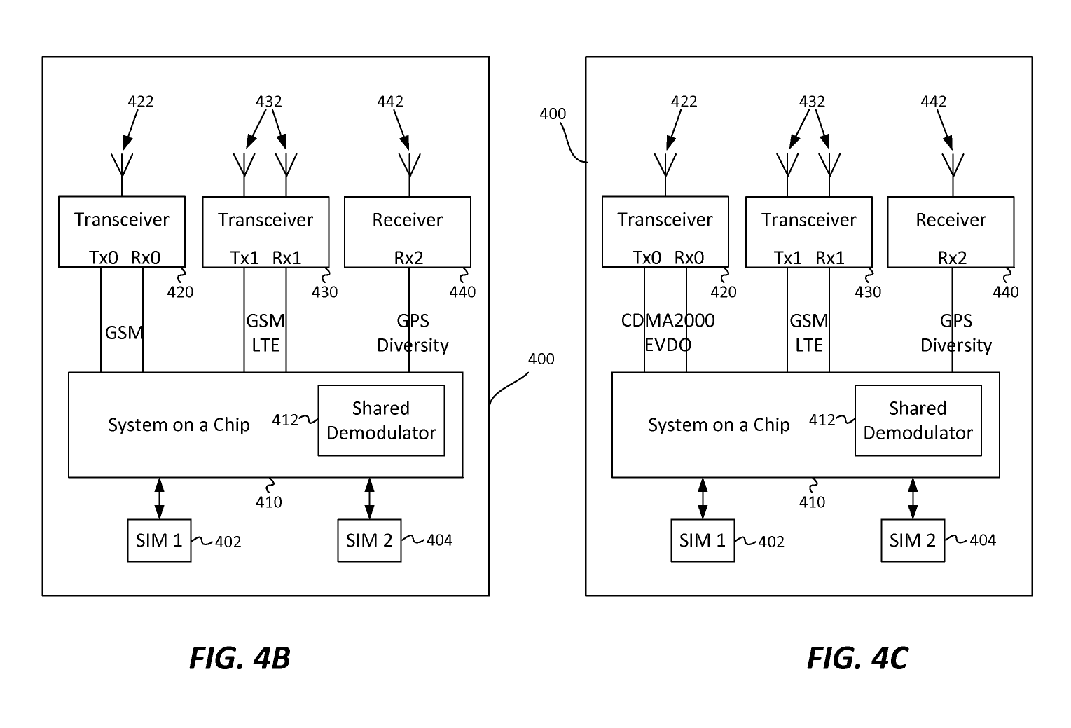

FIG. 4A is a schematic diagram illustrating an example of a UE 400 according to various embodiments. With reference to FIGS. 1-4, the UE 400 may correspond to the UE 110, 200. According to some embodiments, the UE 400 may contain: SIM 1 402; SIM 2 404; system on a chip 410; shared resource 412; first transceiver 420; second transceiver 430; receiver 440; and antennas 422, 432, and 442.

In some embodiments, the SIM 1 402 and the SIM 2 404 may be subscriber identity modules that provide subscriptions for multiple RATs. The SIM 1 402 and the SIM 2 404 may be provided similar to the SIM A 206 and the SIM B 207.

In some embodiments, the system on a chip 410 may include various components used for the operation of the UE 400, such as a processor, memory, and some RF resources. The system on a chip 410 may be provided as a combination of the processor 201, the memory 202, and portions of the RF resources 204. With respect to RF resources, the system on a chip 410 may be configured to contain components related to a modem functionality but not components related to transceiver functionality. For example, the system on a chip 410 may contain modulation and demodulation components. According to some embodiments, the system on a chip 410 may have the shared resource 412. The system on a chip 410 may be coupled to the first transceiver 420, the second transceiver 430, and the receiver 440. The shared resource 412 may be a component used by more than one of the first transceiver 420, the second transceiver 430, and the receiver 440, such as a shared modem resource, thereby being shared between more than one of those components. This configuration may be preferred in order to reduce the size of the system on a chip 410 and/or the cost of producing the system on a chip 410. The system on a chip 410 may contain other shared components other than the shared resource 412.

In some embodiments, the first transceiver 420 may include a transmitter Tx0 and receiver Rx0 for communication using one or more RATs. The first transceiver 420 may support communication using multiple RATs by, for example, supporting active use of a single RAT at a given time and alternating between active use of the different RATs. The first transceiver 420 may use the antenna 422 to perform communication.

In some embodiments, the second transceiver 430 may include a transmitter Tx1 and receiver Rx1 for communication using more than one RAT. The second transceiver 430 may support communication using multiple RATs by, for example, supporting active use of a single RAT at a given time and alternating between active use of the different RATs. The second transceiver 430 may use the antennas 432 to perform communication. The antennas 432 may be a MIMO pair of antennas.

In some embodiments, the receiver 440 may include receiver Rx2 for support of receive-only communications using a variety of technologies. The receiver 440 may use the antenna 442 to perform communication. The receiver 440 may be configured to receive global positioning system (GPS) signals. The receiver 440 may further be configured to function as a spatial diversity receiver in the downlink for a RAT that is in active communication on the first transceiver 420 or the second transceiver 430. In such situations, the signals received from Rx2 of the receiver 440 may be combined with the signals received from Rx0 or Rx1 of the transceiver 320 or the transceiver 330, respectively, so as to allow a more accurate determination of the transmitted symbol. This use of the receiver 440 for spatial diversity may be especially important in situations where the quality of the communications channel between the UE 400 and the base station (e.g., base station 120) is poor.

Because the UE 400 contains both the first transceiver 420 and the second transceiver 430, the UE 400 may support active communication on more than one RAT at a given time. This may be referred to as dual SIM dual active (DSDA) in some situations. Nonetheless, each of the first transceiver 420 and the second transceiver 430 may only be able to support active communication for a single RAT at a given time. For example, if a first RAT is performing active communication on the second transceiver 430, then a second RAT may need to be placed in a traffic suspended state on the second transceiver 430. At the same time, a third RAT may be performing active communication on the first transceiver 420, and a fourth RAT may be in a suspended, idle, or other non-active state on the first transceiver 420. In some situations, the second RAT and/or fourth RAT may lose its connection with its relevant base station, access point, or other network component due to an extended period of inactivity in the suspended state. In some situations, it may be possible to reduce this problem be periodically performing a tune-away procedure, whereby the first transceiver 420 and/or the second transceiver 430 is briefly taken away from its use by the third RAT or first RAT, respectively, and instead used by the fourth RAT or second RAT, respectively. One common approach to the tune-away technique involves periodically using the first transceiver 420 or the second transceiver 430 to monitor a paging channel for the fourth RAT or second RAT, respectively, even though the third RAT or first RAT, respectively, is performing active communication on the first transceiver 420 or the second transceiver 430, respectively.

In some embodiments, a different technique may be used to support suspended state communication for the second RAT while the first RAT is performing active communication on the second transceiver 430. In particular, the UE 400 may use the receiver 440 to perform downlink reception communication for the second RAT. This technique may be effective to perform communications such as a public land mobile network (PLMN) scan, monitoring of a paging channel, or other downlink reception-only communications. In order to allow this, the UE 400 may have to momentarily take the receiver 440 away from some other existing use, such as reception of GPS signals or use for spatial diversity for the first RAT active communication taking place on the second transceiver 430. Nonetheless, this technique has the benefit of still allowing the first RAT to continue active communication on the second transceiver 430 without interruption. In this way, the use of the receiver 440 for downlink reception-only communications for the second RAT may be beneficial for not significantly impacting the active communication taking place on the second transceiver 430 for the first RAT. Concurrent with this technique, the same approach may be applied to the third RAT and fourth RAT and the first transceiver 420. Alternatively, the first transceiver 420 may use a tune-away technique instead of the technique used by the first RAT and second RAT and the second transceiver 430.

FIG. 4B is a schematic diagram illustrating an example of a user equipment according to various embodiments. FIG. 4B shows the same components as FIG. 4A, but exemplary RATs are noted for the first transceiver 420, the second transceiver 430, and the receiver 440. In particular, in the embodiments of FIG. 4B, the first transceiver 420 may support communication using a GSM RAT, and the second transceiver 430 may support communication using both a GSM RAT and an LTE RAT. In some situations, this configuration may be referred to as a SGLTE+G configuration. As indicated, the receiver 440 may support reception of GPS signals as well as use for spatial diversity to support reception of downlink signals by the first transceiver 420 or the second transceiver 430. In some embodiments the shared resource 412 may be a shared demodulator 412.

An exemplary description can be given based on the example RATs noted in FIG. 4B. The GSM RAT of the second transceiver 430 may be a first RAT. The LTE RAT of the second transceiver 430 may be a second RAT. The GSM RAT of the first transceiver 420 may be a third RAT. At some point, the LTE RAT may be performing active communication on the second transceiver 430. However, the UE 400 may receive an incoming circuit-switched voice call for the GSM RAT on the second transceiver 430. At this point, the UE 400 may switch the second transceiver 430 to provide active communication to the GSM RAT. As such, the LTE RAT may be placed in a traffic suspended state. If the UE 400 moves out of range of the base station through which the UE 400 was connected to an LTE network, then the UE 400 may eventually need to perform a reacquisition process when the GSM voice call ends and the LTE traffic is resumed. However, the reacquisition process can introduce unacceptable latency, to such an extent that a user may become aware of the latency and be dissatisfied. In addition, active communication, idle communication, or no communication may be occurring for the GSM RAT on the first transceiver 420.

To avoid the issue of a lengthy reacquisition of the LTE network, the UE 400 may be able to perform some of the reacquisition communications for the LTE RAT before the GSM voice call on the second transceiver 430 has terminated. In particular, the UE 400 may periodically use the receiver 440 to receive broadcast signals from base stations of the LTE RAT. These broadcast signals may include PLMN identifiers of the LTE networks to which the base stations belong. This PLMN search or PLMN scan may typically be performed as one of the early steps in the reacquisition process once the GSM voice call ends on the second transceiver 430. Namely, once the GSM voice call ends, the PLMN search may be necessary in order to identify which LTE networks are presently available after the movement of the UE 400. However, because the PLMN search requires only reception of downlink signals (and not transmission of uplink signals), the PLMN search can be performed using the receiver 440 for the LTE RAT even while the GSM RAT is performing active communication on the second transceiver 430.

At the same time, a determination may need to be made as to when the shared demodulator 412 is available for processing the broadcast signals received for the LTE RAT using the receiver 440. It may be determined that the GSM RAT on the first transceiver 420 and the GSM RAT on the second transceiver 430 do not need to use the shared demodulator 412, so that the PLMN search can be performed for the LTE RAT using the receiver 440 at any point during the GSM voice call on the second transceiver 430. When the GSM voice call ends on the second transceiver 430, the UE 400 may perform the reacquisition process for the LTE RAT without having to perform a PLMN search. Namely, though a PLMN search would typically be performed as an early step in reacquisition of the LTE RAT, the PLMN search may be skipped. Instead, the results of a previously performed PLMN search may be used. In particular, the results of the PLMN search most recently performed with the receiver 440 may be used instead of performing a new PLMN search. Thereby, the UE 400 may avoid the delay in time associated with performing the PLMN search. As such, the reacquisition process for the LTE RAT may be considerably shorter, thereby restoring the active LTE communication on the second transceiver 430 more rapidly than would otherwise be possible. This may positively impact the user of the UE 400 due to this decrease in latency of resuming LTE communications after termination of the GSM voice call.

FIG. 4C is a schematic diagram illustrating an example of a user equipment according to various embodiments. FIG. 4C shows the same components as FIG. 4A, but exemplary RATs are noted for the first transceiver 420, the second transceiver 430, and the receiver 440. In particular, in the embodiments of FIG. 4C, the first transceiver 420 may support communication using both a CDMA2000 RAT and an EVDO RAT, and the second transceiver 430 may support communication using both a GSM RAT and an LTE RAT. In some situations, this configuration may be referred to as a SVLTE+G configuration. As indicated, the receiver 440 may support reception of GPS signals as well as use for spatial diversity to support reception of downlink signals by the first transceiver 420 or the second transceiver 430. In some embodiments, the shared resource 412 may be the shared demodulator 412.

An exemplary description can be given based on the example RATs noted in FIG. 4C. The GSM RAT of the second transceiver 430 may be a first RAT. The LTE RAT of the second transceiver 430 may be a second RAT. The CDMA2000 RAT of the first transceiver 420 may be a third RAT. The EVDO RAT of the first transceiver 420 may be a fourth RAT. At some point, the LTE RAT may be performing active communication on the second transceiver 430. However, the UE 400 may receive an incoming circuit-switched voice call for the GSM RAT on the second transceiver 430. At this point, the UE 400 may switch the second transceiver 430 to provide active communication to the GSM RAT. As such, the LTE RAT may be placed in a traffic suspended state. If the UE 400 moves out of range of the base station through which the UE 400 was connected to an LTE network, then the UE 400 may eventually need to perform a reacquisition process when the GSM voice call ends and the LTE traffic is resumed. However, the reacquisition process can introduce unacceptable latency, to such an extent that a user may become aware of the latency and be dissatisfied.

In addition, various communications may be occurring on the first transceiver 420, such as: active CDMA2000 communication and no EVDO communication; idle CDMA2000 communication and idle EVDO communication; active EVDO communication and idle CDMA2000 communication; active EVDO communication (packet-switched voice call in fallback mode) and idle CDMA 2000 communication; and active EVDO communication (packet-switched voice call in 3G mode) and idle CDMA 2000 communication.

To avoid the issue of a lengthy reacquisition of the LTE network, the UE 400 may be able to perform some of the reacquisition communications for the LTE RAT before the GSM voice call on the second transceiver 430 has terminated. In particular, the UE 400 may periodically use the receiver 440 to receive broadcast signals from base stations of the LTE RAT. These broadcast signals may include PLMN identifiers of the LTE networks to which the base stations belong. This PLMN search or PLMN scan may typically be performed as one of the early steps in the reacquisition process once the GSM voice call ends on the second transceiver 430. Namely, once the GSM voice call ends, the PLMN search may be necessary in order to identify which LTE networks are presently available after the movement of the UE 400. However, because the PLMN search requires only reception of downlink signals (and not transmission of uplink signals), the PLMN search can be performed using the receiver 440 for the LTE RAT even while the GSM RAT is performing active communication on the second transceiver 430.

At the same time, a determination may need to be made as to when the shared demodulator 412 is available for processing the broadcast signals received for the LTE RAT using receiver 440. It may be determined that the CDMA2000 RAT on the first transceiver 420 and the GSM RAT on the second transceiver 430 do not need to use the shared demodulator 412. However, it may be determined that the EVDO RAT on the first transceiver 420 does need to use the shared demodulator 412 when in active communication. As such, the UE 400 may need to determine a time to perform the PLMN search using the receiver 440, such as when: EVDO RAT is idle; EVDO RAT is out of service; or EVDO RAT is active but a tune-away is occurring for the CDMA2000 RAT to monitor the paging channel. Therefore, the UE 400 may perform the PLMN search for the LTE RAT using the receiver 440 during one of these times. Then, when the GSM voice call ends on the second transceiver 430, the UE 400 may perform the reacquisition process for the LTE RAT without having to perform a PLMN search. Namely, though a PLMN search would typically be performed as an early step in reacquisition of the LTE RAT, the PLMN search may be skipped. Instead, the results of a previously performed PLMN search may be used. In particular, the results of the PLMN search most recently performed with the receiver 440 may be used instead of performing a new PLMN search. Thereby, the UE 400 may avoid the delay in time associated with performing the PLMN search. As such, the reacquisition process for the LTE RAT may be considerably shorter, thereby restoring the active LTE communication on the second transceiver 430 more rapidly than would otherwise be possible. This may positively impact the user of the UE 400 due to this decrease in latency of resuming LTE communications after termination of the GSM voice call.

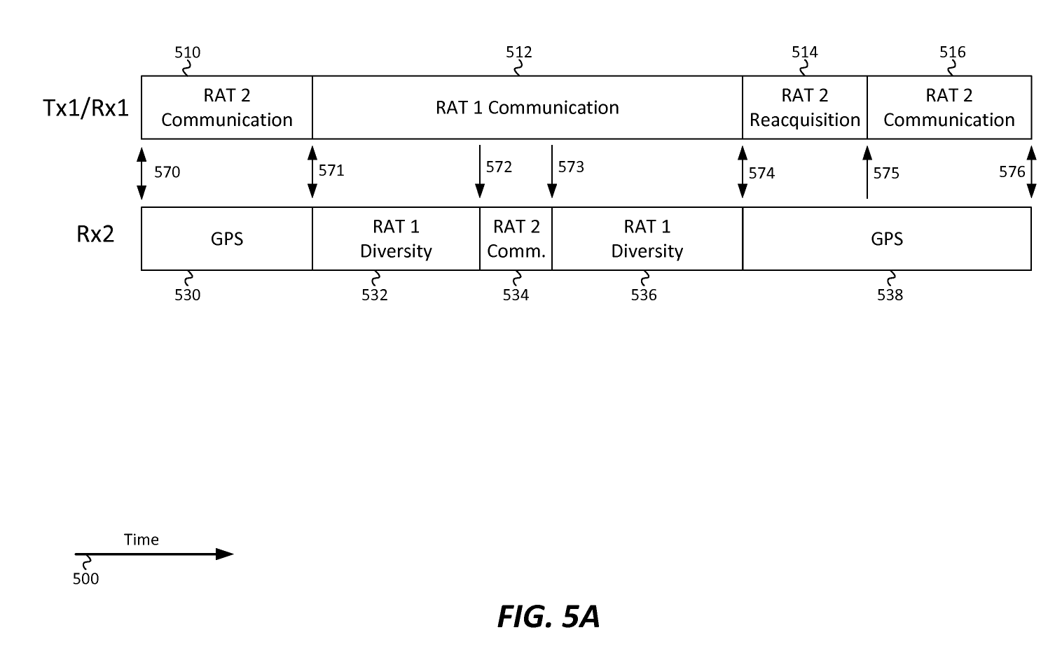

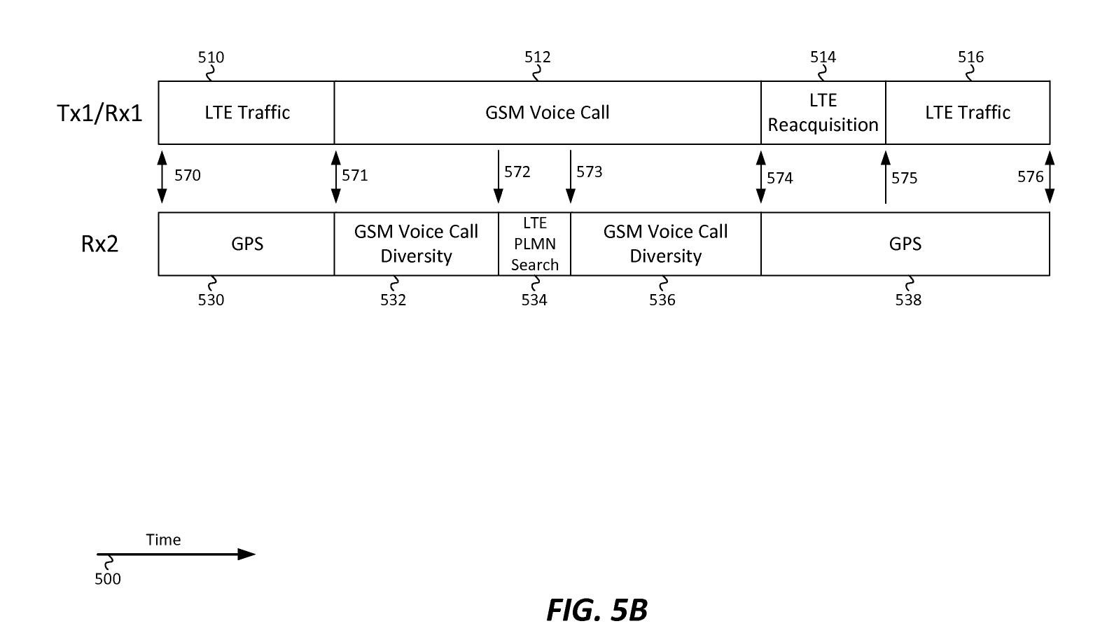

FIG. 5A is a schematic diagram illustrating a communication sequence according to various embodiments. The communication sequence of FIG. 5A may be illustrative of a communication sequence that can be performed using the UE 300 of FIG. 3A. Similar to FIG. 3A, a transceiver containing transmitter Tx1 and receiver Rx1 is shown. Also, a receiver Rx2 is shown. The communication sequence progresses in time from time 570 to time 576 as indicated by time legend 500.

With reference to FIGS. 1-3A and 5A, at the time 570, RAT 2 is performing active communication on Tx1/Rx1 as indicated by time block 510. Also, GPS signals are being received on Rx2 as indicated by time block 530. At time 571, RAT 1 begins active communication on Tx1/Rx1 as indicated by time block 512. As such, RAT 2 may be placed in a suspended state at time 571. Also starting at the time 571, Rx2 provides spatial diversity to the RAT 1 communication as indicated by time block 532. At time 572, the use of Rx2 for spatial diversity is stopped. Also at the time 572, use of Rx2 for RAT 2 communications begins as indicated by time block 534. It should be noted that RAT 1 active communication continues without interruption on Tx1/Rx1. At time 573, the RAT 2 communication on Rx2 stops. Also at the time 573, the use of Rx2 for RAT 1 spatial diversity resumes as indicated by time block 536.

At time 574, the RAT 1 active communication terminates on Tx1/Rx1 as does the use of Rx2 for spatial diversity for RAT 1. Also at the time 574, prior use of Rx2 for reception of GPS signals resumes as indicated by time block 538. Also at the time 574, reacquisition of the RAT 2 connection begins on Tx1/Rx1 as indicated by time block 514. This reacquisition of the time block 514 may involve, for example, sending a registration request to a selected RAT 1 network identified by a particular PLMN. However, a PLMN search may be skipped as part of the reacquisition of the time block 514 if a PLMN search was already performed during the time block 534. Therefore, the time block 514 may be significantly shorter than the time block 514 would be if the communications during the time block 534 were not performed. As such, the reacquisition procedure performed as part of the time block 514 may be a shortened reacquisition procedure compared to a standard reacquisition procedure that would otherwise be performed. At time 575, reacquisition for RAT 2 is completed, and active communication for RAT 2 is resumed on Tx1/Rx1. The diagram ends at the time 576.

In some embodiments, the actions described as being performed at a particular time may otherwise be performed before, after, or in some other relation to the time identified. For example, Rx2 may begin use for spatial diversity for RAT 1 communication (time block 532) at the time 571 or some time after the time 571. As another example, Rx2 may begin use for RAT 2 communications (time block 534) at the time 572 or some time after the time 572. As another example, Tx1/Rx1 may begin performance of reacquisition for RAT 2 (time block 514) at the time 574 or some time after the time 574. Other modifications of the timing sequence of FIG. 5A are possible.

FIG. 5B is a schematic diagram illustrating a communication sequence according to various embodiments. The communication sequence of FIG. 5B may be illustrative of a communication sequence that can be performed using the UE 300 of FIG. 3B. Similar to FIG. 3B, a transceiver containing transmitter Tx1 and receiver Rx1 is shown. Also, a receiver Rx2 is shown. The communication sequence progresses in time from the time 570 to the time 576 as indicated by the time legend 500.

With reference to FIGS. 1-3B and 5B, at the time 570, the LTE RAT is performing active communication on Tx1/Rx1 as indicated by the time block 510. Also, GPS signals are being received on Rx2 as indicated by the time block 530. At the time 571, the GSM RAT begins active communication as part of a voice call on Tx1/Rx1 as indicated by the time block 512. As such, the LTE RAT may be placed in a suspended state at the time 571. Also starting at the time 571, Rx2 provides spatial diversity to the GSM RAT communication as indicated by the time block 532. At the time 572, the use of Rx2 for spatial diversity is stopped. Also at the time 572, use of Rx2 for LTE communications begins as indicated by the time block 534. In the time block 534, a PLMN search is performed for the LTE RAT. It should be noted that the GSM RAT active communication continues without interruption on Tx1/Rx1. At the time 573, the LTE communication on Rx2 stops. Also at the time 573, the use of Rx2 for the GSM RAT spatial diversity resumes as indicated by the time block 536.

At the time 574, the GSM RAT active communication terminates on Tx1/Rx1 as does the use of Rx2 for spatial diversity for the GSM RAT. Also at the time 574, prior use of Rx2 for reception of GPS signals resumes as indicated by the time block 538. Also at the time 574, reacquisition of the LTE connection begins on Tx1/Rx1 as indicated by the time block 514. This reacquisition of the time block 514 may involve, for example, sending a registration request to a selected LTE network identified by a particular PLMN. However, a PLMN search may be skipped as part of the reacquisition of the time block 514 if a PLMN search was already performed during the time block 534. Therefore, the time block 514 may be significantly shorter than the time block 514 would be if the communications during the time block 534 were not performed. As such, the reacquisition procedure performed as part of the time block 514 may be a shortened reacquisition procedure compared to a standard reacquisition procedure that would otherwise be performed. At the time 575, reacquisition for the LTE RAT is completed, and active communication for the LTE RAT is resumed on Tx1/Rx1. The diagram ends at the time 576.

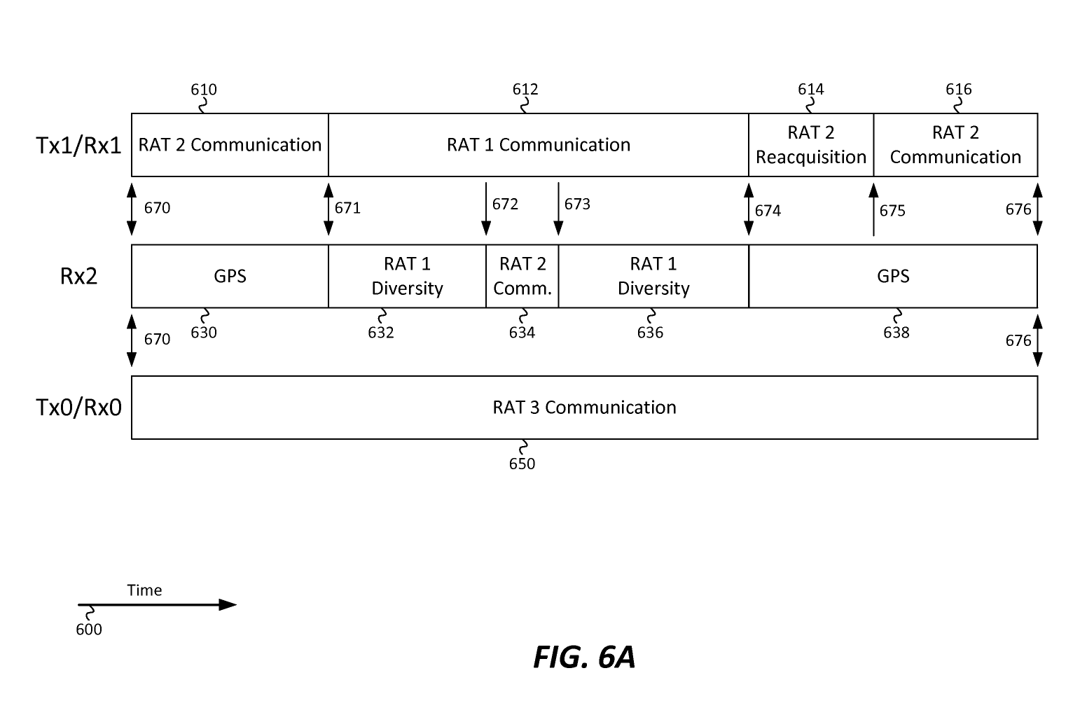

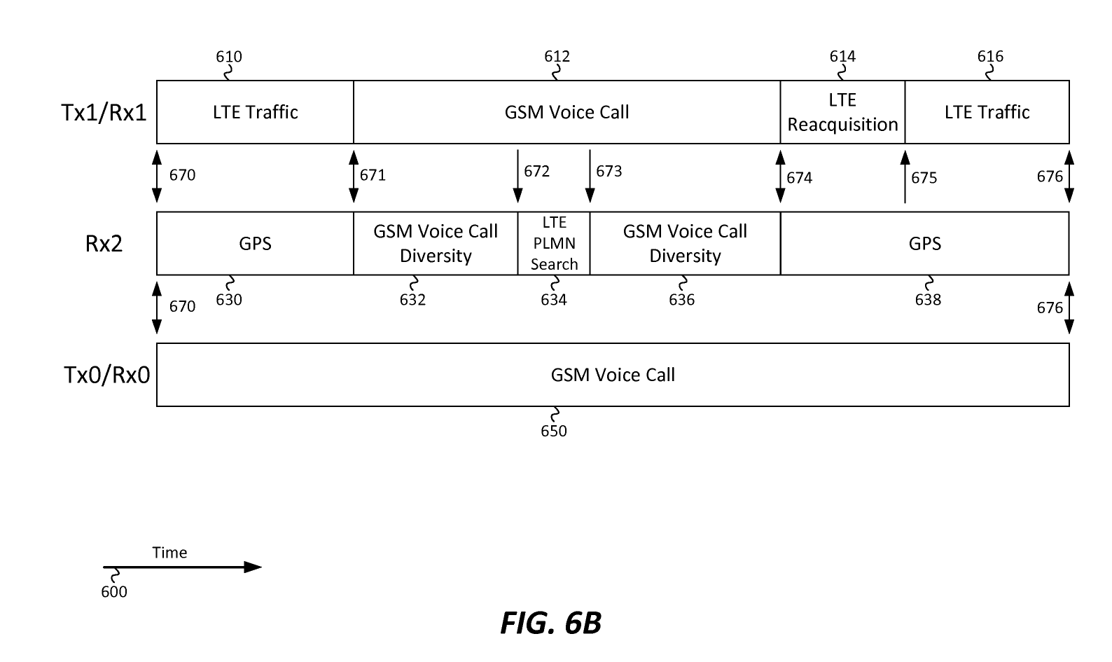

FIG. 6A is a schematic diagram illustrating a communication sequence according to various embodiments. The communication sequence of FIG. 6A may be illustrative of a communication sequence that can be performed using the UE 400 of FIG. 4A. Similar to FIG. 4A, a transceiver containing transmitter Tx0 and receiver Rx0 is shown. Also, a transceiver containing transmitter Tx1 and receiver Rx1 is shown. Also, a receiver Rx2 is shown. The communication sequence progresses in time from time 670 to time 676 as indicated by time legend 600.

With reference to FIGS. 1-4A and 6A, at the time 670, RAT 2 is performing active communication on Tx1/Rx1 as indicated by time block 610. Also, GPS signals are being received on Rx2 as indicated by time block 630. Also, RAT 3 is performing active communication on Tx0/Rx0 as indicated by time block 650. At time 671, RAT 1 begins active communication on Tx1/Rx1 as indicated by time block 612. As such, RAT 2 may be placed in a suspended state at the time 671. Also starting at the time 671, Rx2 provides spatial diversity to the RAT 1 communication as indicated by time block 632. At time 672, the use of Rx2 for spatial diversity is stopped. Also at the time 672, use of Rx2 for RAT 2 communications begins as indicated by time block 634. It should be noted that RAT 1 active communication continues without interruption on Tx1/Rx1. At time 673, the RAT 2 communication on Rx2 stops. Also at the time 673, the use of Rx2 for RAT 1 spatial diversity resumes as indicated by time block 636.

At time 674, the RAT 1 active communication terminates on Tx1/Rx1 as does the use of Rx2 for spatial diversity for RAT 1. Also at the time 674, prior use of Rx2 for reception of GPS signals resumes as indicated by time block 638. Also at the time 674, reacquisition of the RAT 2 connection begins on Tx1/Rx1 as indicated by time block 614. This reacquisition of the time block 614 may involve, for example, sending a registration request to a selected RAT 1 network identified by a particular PLMN. However, a PLMN search may be skipped as part of the reacquisition of the time block 614 if a PLMN search was already performed during the time block 634. Therefore, the time block 614 may be significantly shorter than the time block 614 would be if the communications during the time block 634 were not performed. As such, the reacquisition procedure performed as part of the time block 614 may be a shortened reacquisition procedure compared to a standard reacquisition procedure that would otherwise be performed. At time 675, reacquisition for RAT 2 is completed, and active communication for RAT 2 is resumed on Tx1/Rx1. During these communications on Tx1/Rx1 and Rx2, the communication on Tx0/Rx0 may continue without any effect if it is determined that RAT 3 does not use a shared resource that is also needed for the RAT 2 communication during the time block 634. The diagram ends at the time 676.

In some embodiments, the actions described as being performed at a particular time may otherwise be performed before, after, or in some other relation to the time identified. For example, Rx2 may begin use for spatial diversity for RAT 1 communication (time block 632) at the time 671 or some time after the time 671. As another example, Rx2 may begin use for RAT 2 communications (time block 634) at the time 672 or some time after the time 672. As another example, Tx1/Rx1 may begin performance of reacquisition for RAT 2 (time block 614) at the time 674 or some time after the time 674. Other modifications of the timing sequence of FIG. 6A are possible.

FIG. 6B is a schematic diagram illustrating a communication sequence according to various embodiments. The communication sequence of FIG. 6B may be illustrative of a communication sequence that can be performed using the UE 400 of FIG. 4B. Similar to FIG. 4B, a transceiver containing transmitter Tx0 and receiver Rx0 is shown. Also, a transceiver containing transmitter Tx1 and receiver Rx1 is shown. Also, a receiver Rx2 is shown. The communication sequence progresses in time from the time 670 to the time 676 as indicated by the time legend 600.

With reference to FIGS. 1-4B and 6B, at the time 670, the LTE RAT is performing active communication on Tx1/Rx1 as indicated by the time block 610. Also, GPS signals are being received on Rx2 as indicated by the time block 630. Also, he GSM RAT is performing active communication on Tx0/Rx0 as indicated by the time block 650. At the time 671, the GSM RAT begins active communication as part of a voice call on Tx1/Rx1 as indicated by the time block 612. As such, the LTE RAT may be placed in a suspended state at the time 671. Also starting at the time 671, Rx2 provides spatial diversity to the GSM RAT communication as indicated by the time block 632. At the time 672, the use of Rx2 for spatial diversity is stopped. Also at the time 672, use of Rx2 for LTE communications begins as indicated by the time block 634. In the time block 634, a PLMN search is performed for the LTE RAT. It should be noted that the GSM RAT active communication continues without interruption on Tx1/Rx1. At the time 673, the LTE communication on Rx2 stops. Also at the time 673, the use of Rx2 for the GSM RAT spatial diversity resumes as indicated by the time block 636.

At the time 674, the GSM RAT active communication terminates on Tx1/Rx1 as does the use of Rx2 for spatial diversity for the GSM RAT. Also at the time 674, prior use of Rx2 for reception of GPS signals resumes as indicated by the time block 638. Also at the time 674, reacquisition of the LTE connection begins on Tx1/Rx1 as indicated by the time block 614. This reacquisition of the time block 614 may involve, for example, sending a registration request to a selected LTE network identified by a particular PLMN. However, a PLMN search may be skipped as part of the reacquisition of the time block 614 if a PLMN search was already performed during the time block 634. Therefore, the time block 614 may be significantly shorter than the time block 614 would be if the communications during the time block 634 were not performed. As such, the reacquisition procedure performed as part of the time block 614 may be a shortened reacquisition procedure compared to a standard reacquisition procedure that would otherwise be performed. At the time 675, reacquisition for the LTE RAT is completed, and active communication for the LTE RAT is resumed on Tx1/Rx1. During these communications on Tx1/Rx1 and Rx2, the communication on Tx0/Rx0 may continue without any effect if it is determined that the GSM RAT does not use a shared resource that is also needed for the LTE communication during the time block 634. The diagram ends at the time 676.

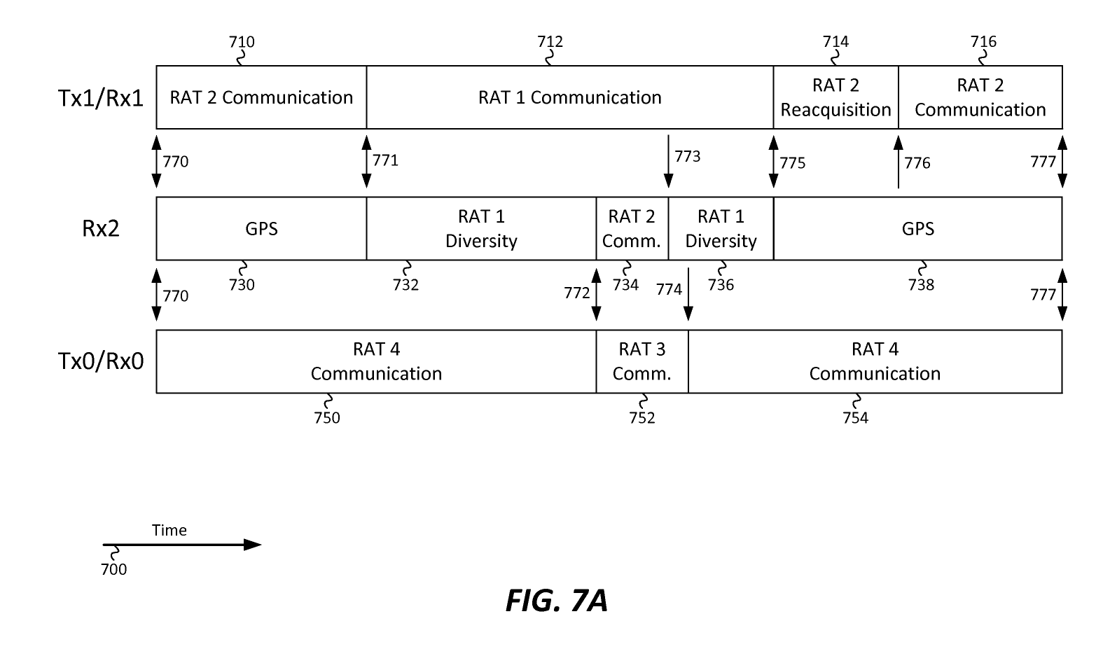

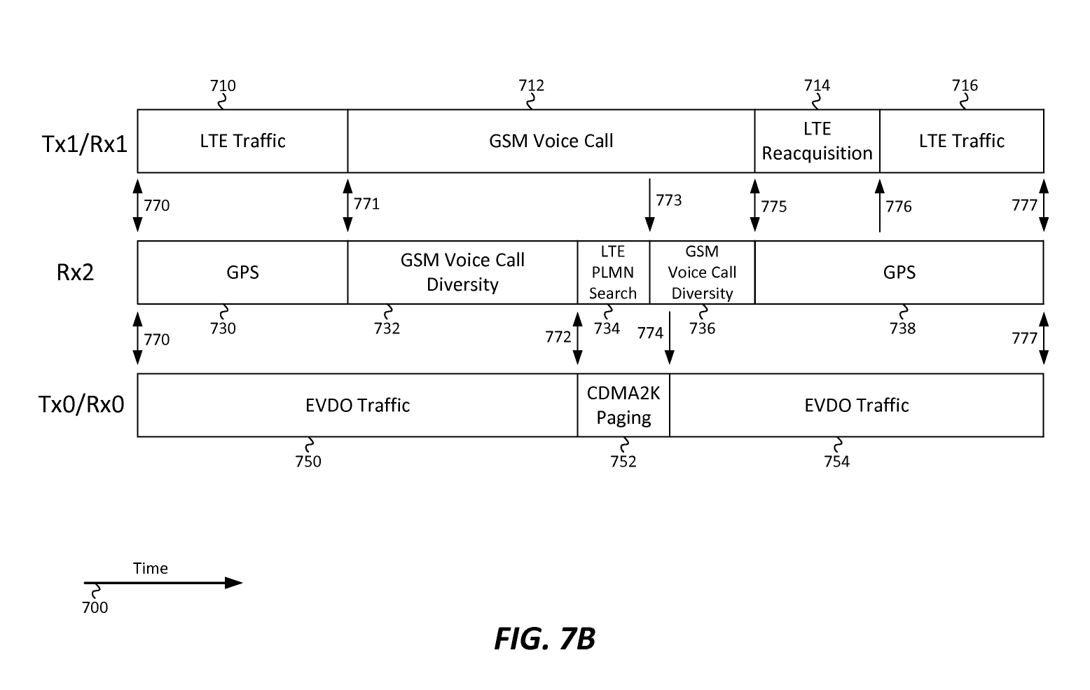

FIG. 7A is a schematic diagram illustrating a communication sequence according to various embodiments. The communication sequence of FIG. 7A may be illustrative of a communication sequence that can be performed using the UE 400 of FIG. 4A. Similar to FIG. 4A, a transceiver containing transmitter Tx0 and receiver Rx0 is shown. Also, a transceiver containing transmitter Tx1 and receiver Rx1 is shown. Also, a receiver Rx2 is shown. The communication sequence progresses in time from time 770 to time 777 as indicated by time legend 700.

With reference to FIGS. 1-4A and 7A, at the time 770, RAT 2 is performing active communication on Tx1/Rx1 as indicated by time block 710. Also, GPS signals are being received on Rx2 as indicated by time block 730. Also, RAT 4 is performing active communication on Tx0/Rx0 as indicated by time block 750. At time 771, RAT 1 begins active communication on Tx1/Rx1 as indicated by time block 712. As such, RAT 2 may be placed in a suspended state at the time 771. Also starting at the time 771, Rx2 provides spatial diversity to the RAT 1 communication as indicated by time block 732.

At time 772, the RAT 4 active communication on Tx0/Rx0 stops. Also at the time 772, RAT 3 communication begins on Tx0/Rx0 as indicated by time block 752. The processing of the time block 752 may be, for example, a tune-away procedure from RAT 4 to RAT 3 and then back to RAT 4. It may have been determined that the RAT 4 active communication during the time block 750 utilized a shared resource (e.g., a shared demodulator component) that is necessary for the RAT 2 communication of time block 734. Therefore, the time 772 may be selected as a time to stop the use of Rx2 for RAT 1 spatial diversity and start the use of Rx2 for RAT 2 communication, as indicated by the time block 734. It should be noted that RAT 1 active communication continues without interruption on Tx1/Rx1. At time 773, the RAT 2 communication on Rx2 stops. Also at the time 773, the use of Rx2 for RAT 1 spatial diversity resumes as indicated by time block 736. At time 774, the RAT 3 communication on Tx0/Rx0 stops, and RAT 4 active communication on Tx0/Rx0 resumes as indicated by time block 754. Therefore, the time block 734 is performed in the time interval covered by the time block 752 so that a shared resource needed for both RAT 2 communications (time block 734) and RAT 4 communications (time blocks 750 and 754) can be used individually by each at different times.

At time 775, the RAT 1 active communication terminates on Tx1/Rx1 as does the use of Rx2 for spatial diversity for RAT 1. Also at the time 775, prior use of Rx2 for reception of GPS signals resumes as indicated by time block 738. Also at the time 775, reacquisition of the RAT 2 connection begins on Tx1/Rx1 as indicated by time block 714. This reacquisition of the time block 714 may involve, for example, sending a registration request to a selected RAT 1 network identified by a particular PLMN. However, a PLMN search may be skipped as part of the reacquisition of the time block 714 if a PLMN search was already performed during the time block 734. Therefore, the time block 714 may be significantly shorter than the time block 714 would be if the communications during the time block 734 were not performed. As such, the reacquisition procedure performed as part of the time block 714 may be a shortened reacquisition procedure compared to a standard reacquisition procedure that would otherwise be performed. At time 776, reacquisition for RAT 2 is completed, and active communication for RAT 2 is resumed on Tx1/Rx1. The diagram ends at the time 777.

In some embodiments, the actions described as being performed at a particular time may otherwise be performed before, after, or in some other relation to the time identified. For example, Rx2 may begin use for spatial diversity for RAT 1 communication (time block 732) at the time 771 or some time after the time 771. As another example, Rx2 may begin use for RAT 2 communications (time block 734) at the time 772 or some time after the time 772. As another example, Tx1/Rx1 may begin performance of reacquisition for RAT 2 (time block 714) at the time 775 or some time after the time 775. Other modifications of the timing sequence of FIG. 7A are possible.

FIG. 7B is a schematic diagram illustrating a communication sequence according to various embodiments. The communication sequence of FIG. 7B may be illustrative of a communication sequence that can be performed using the UE 400 of FIG. 4C. Similar to FIG. 4C, a transceiver containing transmitter Tx0 and receiver Rx0 is shown. Also, a transceiver containing transmitter Tx1 and receiver Rx1 is shown. Also, a receiver Rx2 is shown. The communication sequence progresses in time from the time 770 to the time 776 as indicated by the time legend 700.

With reference to FIGS. 1-4C and 7B, at the time 770, the LTE RAT is performing active communication on Tx1/Rx1 as indicated by the time block 710. Also, GPS signals are being received on Rx2 as indicated by the time block 730. Also, the EVDO RAT is performing active communication on Tx0/Rx0 as indicated by the time block 750. At the time 771, the GSM RAT begins active communication on Tx1/Rx1 as indicated by the time block 712. As such, the LTE RAT may be placed in a suspended state at the time 771. Also starting at the time 771, Rx2 provides spatial diversity to the GSM RAT communication as indicated by the time block 732.

At the time 772, the EVDO RAT active communication on Tx0/Rx0 stops. Also at the time 772, CDMA2000 communication begins on Tx0/Rx0 as indicated by the time block 752. The processing of the time block 752 may be, for example, a tune-away procedure from the EVDO RAT to the CDMA2000 RAT to allow monitoring of the CDMA2000 paging channel. It may have been determined that the EVDO RAT active communication during the time block 750 utilized a shared resource (e.g., a shared demodulator component) that is necessary for the LTE RAT communication of the time block 734. Therefore, the time 772 may be selected as a time to stop the use of Rx2 for the GSM RAT spatial diversity and start the use of Rx2 for the LTE RAT communication, as indicated by the time block 734. It should be noted that the GSM RAT active communication continues without interruption on Tx1/Rx1. At the time 773, the LTE RAT communication on Rx2 stops. Also at the time 773, the use of Rx2 for the GSM RAT spatial diversity resumes as indicated by the time block 736. At the time 774, the CDMA2000 RAT communication on Tx0/Rx0 stops, and the EVDO RAT active communication on Tx0/Rx0 resumes as indicated by the time block 754. Therefore, the time block 734 is performed in the time interval covered by the time block 752 so that a shared resource needed for both the LTE RAT communications (time block 734) and the EVDO RAT communications (time blocks 750 and 754) can be used individually by each at different times.

At the time 775, the GSM RAT active communication terminates on Tx1/Rx1 as does the use of Rx2 for spatial diversity for the GSM RAT. Also at the time 775, prior use of Rx2 for reception of GPS signals resumes as indicated by the time block 738. Also at the time 775, reacquisition of the LTE RAT connection begins on Tx1/Rx1 as indicated by the time block 714. This reacquisition of the time block 714 may involve, for example, sending a registration request to a selected LTE network identified by a particular PLMN. However, a PLMN search may be skipped as part of the reacquisition of the time block 714 if PLMN search was already performed during the time block 734. Therefore, the time block 714 may be significantly shorter than the time block 714 would be if the communications during the time block 734 were not performed. As such, the reacquisition procedure performed as part of the time block 714 may be a shortened reacquisition procedure compared to a standard reacquisition procedure that would otherwise be performed. At the time 776, reacquisition for the LTE RAT is completed, and active communication for the LTE RAT is resumed on Tx1/Rx1. The diagram ends at the time 777.

Though particular examples of communication sequences have been shown in the preceding figures, variations from examples are possible in various embodiments. For example, though a single use of Rx2 for the RAT 2 communications is shown in these figures, it is foreseeable that more than one such use of Rx2 for RAT 2 communications may be used. For example, the use of Rx2 for RAT 2 communications as described with reference to FIGS. 5A-7B may be repeated at intervals as the RAT 1 communication on Rx1/Tx1 continues on. In some embodiments, the use of Rx2 for RAT 2 communications may be repeated every 5 seconds. In some embodiments, the use of Rx2 for RAT 2 communications may be repeated every 10 seconds. In some embodiments, the use of Rx2 for RAT 2 communications may be repeated every 40 seconds or other interval. In some embodiments, the RAT 2 may be put into a deep sleep, and the use of Rx2 for RAT 2 communications may be repeated at the termination of the deep sleep. In these various ways and others, the time at which to perform the use of Rx2 for RAT 2 communications may be determined based on when the last such use of Rx2 for RAT 2 communications was performed. This is to say, the time at which to perform the use of Rx2 for RAT 2 communications may be determined based on how much time has passed since the last RAT 2 communication was performed.

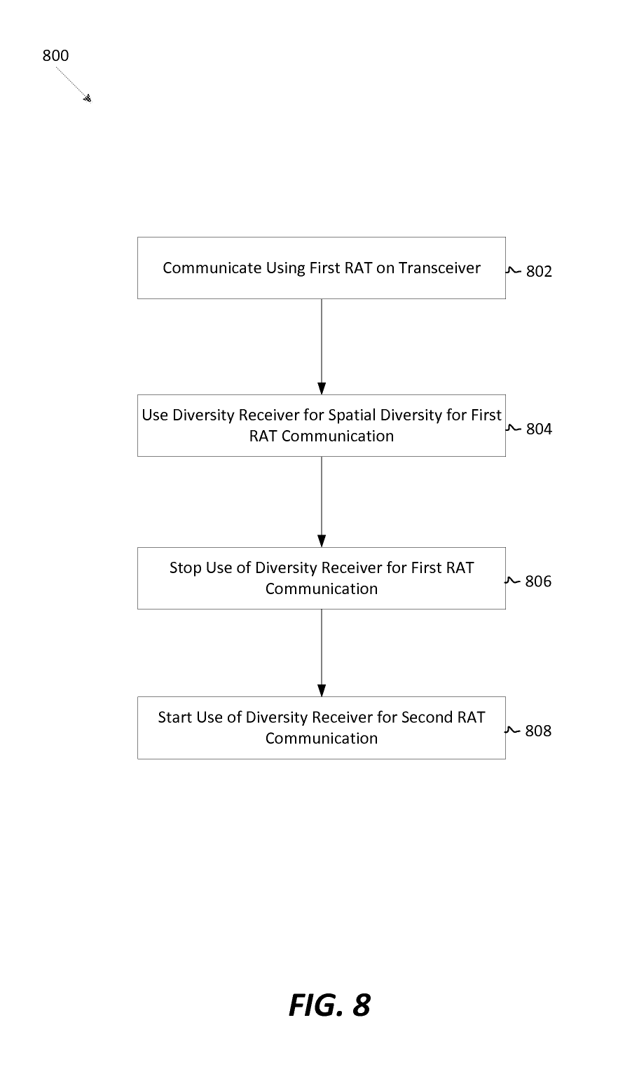

FIG. 8 is a flowchart of a process 800 according to various embodiments. The process 800 may be performed by a UE (e.g., 110, 200, 300, 400 in FIGS. 1-4C).

With reference to FIGS. 1-8, at block 802, communication is performed using a first RAT on a transceiver. The first RAT communication may be an active communication including substantially uninterrupted use of the transmitter and receiver of the transceiver. The first RAT communication on the transceiver may prevent active communication of a second RAT on the transceiver.

At block 804, a diversity receiver is used for spatial diversity for the first RAT communication. The use of the diversity receiver for spatial diversity may be performed to improve the signal quality for the first RAT communication taking place on the transceiver.

At block 806, use of the diversity receiver for spatial diversity for the first RAT communication is stopped. The block 806 may be performed in order to allow performance of block 808.

At the block 808, use of the diversity receiver for communication using a second RAT is started. The second RAT communication may include a downlink receive-only communication. The second RAT communication may include a communication that shortens a later reacquisition of a connection for the second RAT.

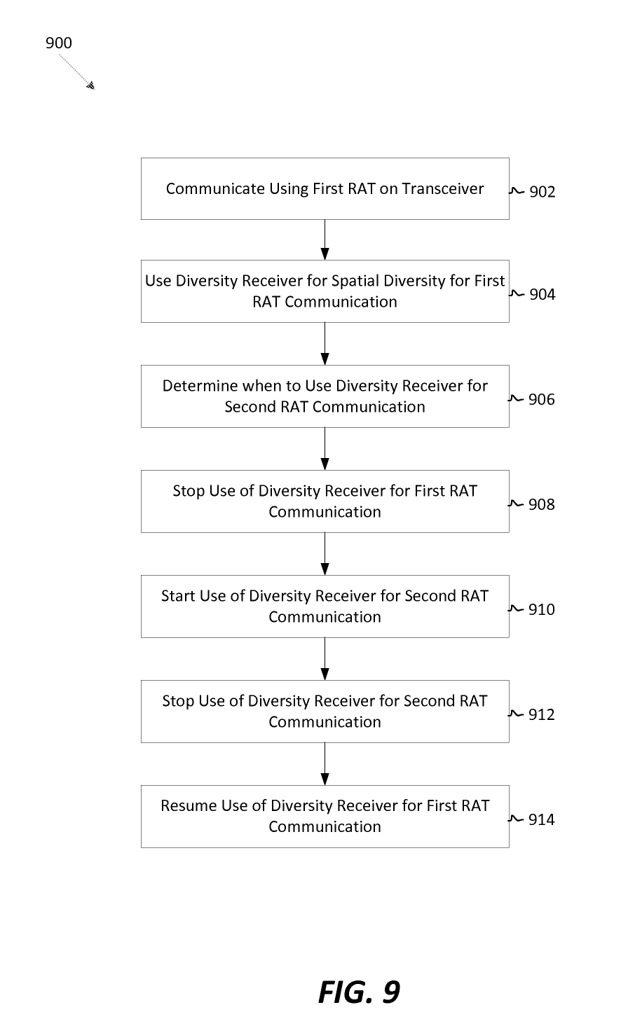

FIG. 9 is a flowchart of a process 900 according to various embodiments. The process 900 may be performed by a UE (e.g., 110, 200, 300, 400 in FIGS. 1-4C).

With reference to FIGS. 1-9, at block 902, communication is performed using a first RAT on a transceiver. The first RAT communication may be an active communication including substantially uninterrupted use of the transmitter and receiver of the transceiver. The first RAT communication on the transceiver may prevent active communication of a second RAT on the transceiver.

At block 904, a diversity receiver is used for spatial diversity for the first RAT communication. The use of the diversity receiver for spatial diversity may be performed to improve the signal quality for the first RAT communication taking place on the transceiver.

At block 906, a determination is made as to when to use the diversity receiver for communication using a second RAT. The determination may be made based on how long has passed since a previous communication was performed using the second RAT. The determination may be made based on the expected availability of a shared resource between multiple transmitter and/or receiver components. The determination may be made based on the expected availability of a shared modem resource between multiple transmitter and/or receiver components. The determination may be made based on the expected availability of a shared demodulator component between multiple transmitter and/or receiver components. The determination may be made based on the expected availability of a shared resource between the transceiver, the diversity receiver, and a third RAT on another transceiver.

At block 908, use of the diversity receiver for spatial diversity for the first RAT communication is stopped. The block 908 may be performed at a time determined as part of the block 906. The block 908 may be performed in order to allow performance of block 910.

At the block 910, use of the diversity receiver for communication using a second RAT is started. The second RAT communication may include a downlink receive-only communication. The second RAT communication may include a communication that shortens a later reacquisition of a connection for the second RAT. The block 910 may be performed at a time determined as part of the block 906.

At block 912, use of the diversity receiver for communication using the second RAT is stopped. The block 912 may be performed based on the completion of a communication process started as part of the block 910. The block 912 may be performed based on the completion of a PLMN search started as part of the block 910. The block 912 may be performed based on the termination of availability of a shared resource being used for the second RAT communication.

At block 914, use of the diversity receiver for spatial diversity for the first RAT communication is resumed. The block 914 may be performed as a result of the block 912.

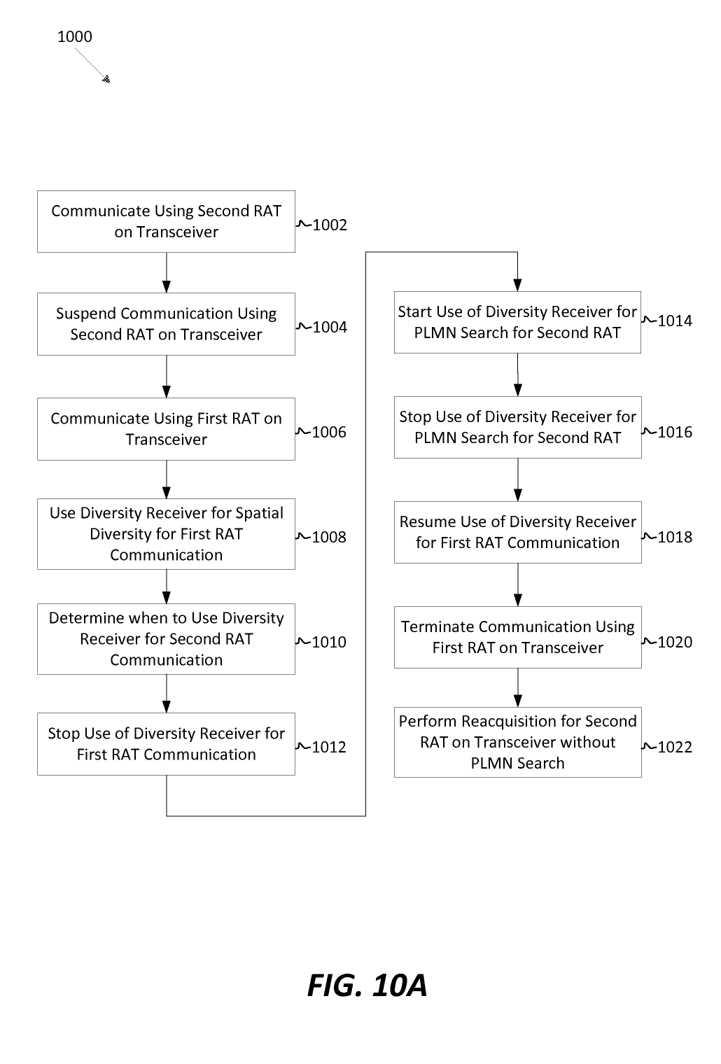

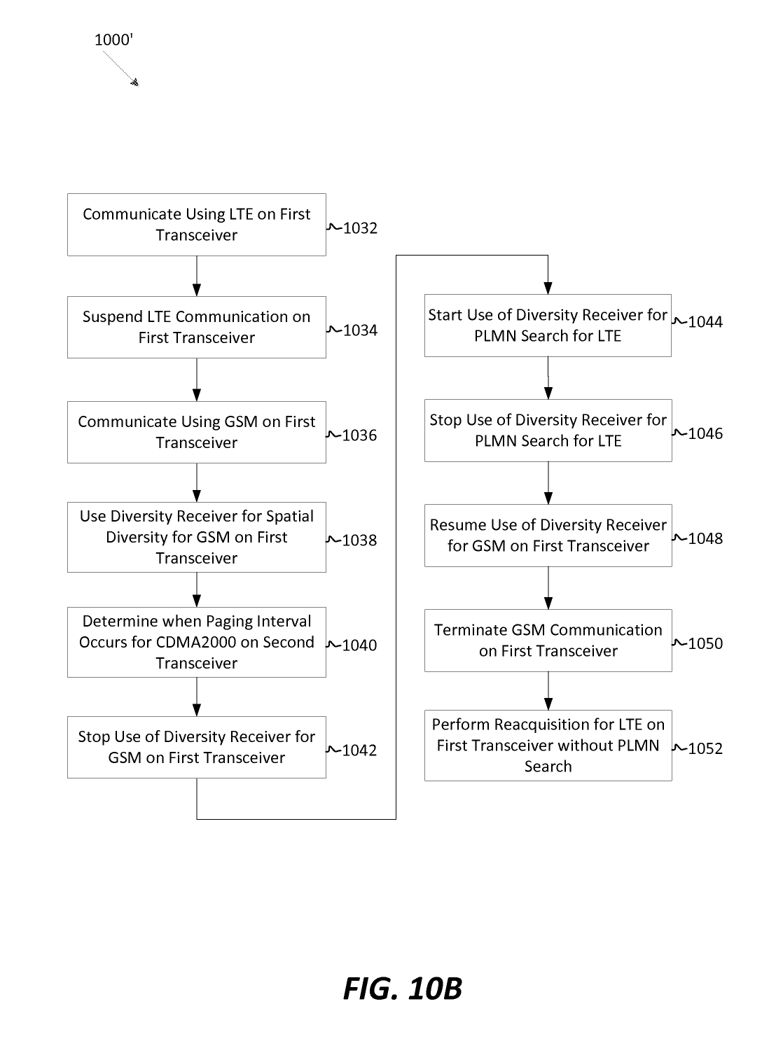

FIG. 10A is a flowchart of a process 1000 according to various embodiments. The process 1000 may be performed by a UE (e.g., 110, 200, 300, 400 in FIGS. 1-4C).

With reference to FIGS. 1-10A, at block 1002, communication is performed using a second RAT on a transceiver. The second RAT communication may be an active communication using the transmitter and receiver of the transceiver.

At block 1004, communication using the second RAT on the transceiver is suspended. Suspending the second RAT communication may include halting sending and receiving of data packets for the second RAT. The block 1004 may be performed in order to allow performance of block 1006.

At the block 1006, communication is performed using a first RAT on the transceiver. The first RAT communication may be an active communication including substantially uninterrupted use of the transmitter and receiver of the transceiver. The first RAT communication on the transceiver may prevent active communication of a second RAT on the transceiver.

At block 1008, a diversity receiver is used for spatial diversity for the first RAT communication. The use of the diversity receiver for spatial diversity may be performed to improve the signal quality for the first RAT communication taking place on the transceiver.

At block 1010, a determination is made as to when to use the diversity receiver for communication using the second RAT. The determination may be made based on how long has passed since a previous communication was performed using the second RAT. The determination may be made based on the expected availability of a shared resource between multiple transmitter and/or receiver components. The determination may be made based on the expected availability of a shared modem resource between multiple transmitter and/or receiver components. The determination may be made based on the expected availability of a shared demodulator component between multiple transmitter and/or receiver components. The determination may be made based on the expected availability of a shared resource between the transceiver, the diversity receiver, and a third RAT on another transceiver.

At block 1012, use of the diversity receiver for spatial diversity for the first RAT communication is stopped. The block 1012 may be performed at a time determined as part of the block 1010. The block 1012 may be performed in order to allow performance of block 1014.

At the block 1014, use of the diversity receiver for communication using the second RAT is started. The second RAT communication may include a downlink receive-only communication. The second RAT communication may include a communication that shortens a later reacquisition of a connection for the second RAT. The second RAT communication may include a PLMN search. Block 1014 may be performed at a time determined as part of the block 1010.

At block 1016, use of the diversity receiver for communication using the second RAT is stopped. The block 1016 may be performed based on the completion of a communication process started as part of the block 1014. The block 1016 may be performed based on the completion of a PLMN search started as part of the block 1014. The block 1016 may be performed based on the termination of availability of a shared resource being used for the second RAT communication.

At block 1018, use of the diversity receiver for spatial diversity for the first RAT communication is resumed. The block 1018 may be performed as a result of the block 1016.

At block 1020, communication using the first RAT on the transceiver is terminated. Block 1020 may be performed based on the completion of a voice call for the first RAT.

At block 1022, reacquisition for the second RAT on the transceiver is performed without a PLMN search. The reacquisition may be performed based on the result of a PLMN search performed based on the communication process started as part of the block 1014.

FIG. 10B is a flowchart of a process 1000′ according to various embodiments. The process 1000′ of FIG. 10B is an exemplary embodiment of the process 1000 described with reference to FIG. 10A. The process 1000′ may be performed by a UE (e.g., 110, 200, 300, 400 in FIGS. 1-4C).

With reference to FIGS. 1-10B, at block 1032, communication is performed using an LTE RAT on a transceiver. The LTE RAT communication may be an active communication using the transmitter and receiver of the transceiver.

At block 1034, communication using the LTE RAT on the transceiver is suspended. Suspending the LTE RAT communication may include halting sending and receiving of data packets for the LTE RAT. The block 1034 may be performed in order to allow performance of block 1036.

At the block 1036, communication is performed using a GSM RAT on the transceiver. The GSM RAT communication may be an active communication including substantially uninterrupted use of the transmitter and receiver of the transceiver. The GSM RAT communication on the transceiver may prevent active communication of the LTE RAT on the transceiver.

At block 1038, a diversity receiver is used for spatial diversity for the GSM RAT communication. The use of the diversity receiver for spatial diversity may be performed to improve the signal quality for the GSM RAT communication taking place on the transceiver.

At block 1040, a determination is made as to when to use the diversity receiver for communication using the LTE RAT. The determination may be made based on how long has passed since a previous communication was performed using the LTE RAT. The determination may be made based on the expected availability of a shared resource between multiple transmitter and/or receiver components. The determination may be made based on the expected availability of a shared modem resource between multiple transmitter and/or receiver components. The determination may be made based on the expected availability of a shared demodulator component between multiple transmitter and/or receiver components. The determination may be made based on the expected availability of a shared resource between the transceiver, the diversity receiver, and a CDMA2000 RAT and/or EVDO RAT on another transceiver.

At block 1042, use of the diversity receiver for spatial diversity for the GSM RAT communication is stopped. The block 1042 may be performed at a time determined as part of the block 1040. The block 1042 may be performed in order to allow performance of block 1044.

At the block 1044, use of the diversity receiver for communication using the LTE RAT is started. The LTE RAT communication may include a downlink receive-only communication. The LTE RAT communication may include a communication that shortens a later reacquisition of a connection for the LTE RAT. The LTE RAT communication may include a PLMN search. The block 1044 may be performed at a time determined as part of the block 1040.

At block 1046, use of the diversity receiver for communication using the LTE RAT is stopped. The block 1046 may be performed based on the completion of a communication process started as part of the block 1044. The block 1046 may be performed based on the completion of a PLMN search started as part of the block 1044. The block 1046 may be performed based on the termination of availability of a shared resource being used for the LTE RAT communication.

At block 1048, use of the diversity receiver for spatial diversity for the GSM RAT communication is resumed. The block 1048 may be performed as a result of the block 1046.

At the block 1050, communication using the GSM RAT on the transceiver is terminated. The block 1050 may be performed based on the completion of a voice call for the GSM RAT.

At block 1052, reacquisition for the LTE RAT on the transceiver is performed without a PLMN search. The reacquisition may be performed based on the result of a PLMN search performed based on the communication process started as part of the block 1044.

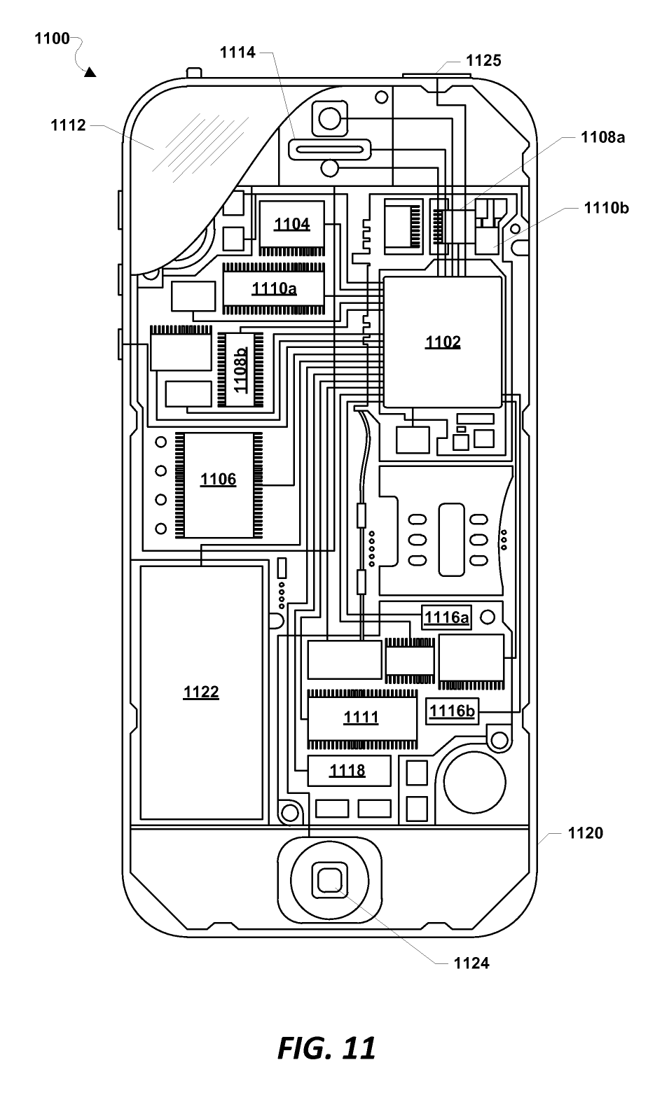

FIG. 11 illustrates an example of a UE 1100, which may correspond to the UEs 110, 200, 300, 400 in FIGS. 1-4C. With reference to FIGS. 1-11, the UE 1100 may include a processor 1102 coupled to a touchscreen controller 1104 and an internal memory 1106. The processor 1102 may correspond to the processor 201. The processor 1102 may be one or more multi-core integrated circuits designated for general or specific processing tasks. The internal memory 1106 may correspond to the memory 202. The memory 1106 may be volatile or non-volatile memory, and may also be secure and/or encrypted memory, or unsecure and/or unencrypted memory, or any combination thereof. The touchscreen controller 1104 and the processor 1102 may also be coupled to a touchscreen panel 1112, such as a resistive-sensing touchscreen, capacitive-sensing touchscreen, infrared sensing touchscreen, etc. Additionally, the display of the UE 1100 need not have touch screen capability. The touch screen controller 1104, the touchscreen panel 1112 may correspond to the user interface 203.

The UE 1100 may have one or more cellular network transceivers 1108a, 1108b coupled to the processor 1102 and to two or more antennae 1110 and configured for sending and receiving cellular communications. The transceivers 1108 and antennae 1110a, 1110b may be used with the above-mentioned circuitry to implement the various embodiment methods. The UE 1100 may include two or more SIM cards 1116a, 1116b, corresponding to SIM A 206 and SIM B 207, coupled to the transceivers 1108a, 1108b and/or the processor 1102 and configured as described above. The UE 1100 may include a cellular network wireless modem chip 1111 that enables communication via a cellular network and is coupled to the processor. The one or more cellular network transceivers 1108a, 1108b, the cellular network wireless modem chip 1111, and the two or more antennae 1110 may correspond to the RF resources 204.

The UE 1100 may include a peripheral device connection interface 1118 coupled to the processor 1102. The peripheral device connection interface 1118 may be singularly configured to accept one type of connection, or multiply configured to accept various types of physical and communication connections, common or proprietary, such as USB, FireWire, Thunderbolt, or PCIe. The peripheral device connection interface 1118 may also be coupled to a similarly configured peripheral device connection port (not shown).

The UE 1100 may also include speakers 1114 for providing audio outputs. The UE 1100 may also include a housing 1120, constructed of a plastic, metal, or a combination of materials, for containing all or some of the components discussed herein. The UE 1100 may include a power source 1122 coupled to the processor 1102, such as a disposable or rechargeable battery. The rechargeable battery may also be coupled to a peripheral device connection port (not shown) to receive a charging current from a source external to the UE 1100. The UE 1100 may also include a physical button 1124 for receiving user inputs. The UE 1100 may also include a power button 1126 for turning the UE 1100 on and off.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to some embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method comprising:
communicating using a first radio access technology on a first transceiver;
using a diversity receiver to provide spatial diversity for the communication using the first radio access technology;
stopping the use of the diversity receiver to provide spatial diversity for the communication using the first radio access technology; and
starting use of the diversity receiver to communicate using a second radio access technology, wherein the communication using the first radio access technology continues on the first transceiver.

2. The method of claim 1,
wherein the stopping the use of the diversity receiver to provide spatial diversity for the communication using the first radio access technology is performed at a first time, and
wherein the starting the use of the diversity receiver to communicate using a second radio access technology is performed at or after the first time.

3. The method of claim 1, further comprising:
stopping the use of the diversity receiver to communicate using the second radio access technology; and
resuming the use of the diversity receiver to provide spatial diversity for the communication using the first radio access technology.

4. The method of claim 3,
wherein the stopping the use of the diversity receiver to communicate using the second radio access technology is performed at a second time, and
wherein the resuming the use of the diversity receiver to provide spatial diversity for the communication using the first radio access technology is performed at or after the second time.

5. The method of claim 3,
wherein the stopping the use of the diversity receiver to provide spatial diversity for the communication using the first radio access technology is performed at a first time,
wherein the starting the use of the diversity receiver to communicate using a second radio access technology is performed at or after the first time,
wherein the stopping the use of the diversity receiver to communicate using the second radio access technology is performed at a second time, and
wherein the resuming the use of the diversity receiver to provide spatial diversity for the communication using the first radio access technology is performed at or after the second time.

6. The method of claim 5,
wherein the first time occurs before the second time, and
wherein the communication using the first radio access technology continues on the first transceiver from the first time to the second time.

7. The method of claim 1,
wherein the first radio access technology is different from the second radio access technology.

8. The method of claim 1, further comprising:
determining when to perform the starting the use of the diversity receiver to communicate using the second radio access technology based on an expected availability of a shared modem resource that is shared between the first transceiver and a second transceiver.

9. The method of claim 8,
wherein the expected availability of the shared modem resource is based on communication using a third radio access technology on the second transceiver.

10. The method of claim 9,
wherein the communication using the third radio access technology on the second transceiver is a paging interval for the third radio access technology.

11. The method of claim 10,
wherein the paging interval for the third radio access technology occurs between periods of communication using a fourth radio access technology on the second transceiver.

12. The method of claim 1,
wherein the use of the diversity receiver to communicate using the second radio access technology comprises performing a public land mobile network (PLMN) search for the second radio access technology.

13. The method of claim 1, further comprising:
performing a shortened reacquisition procedure for the second radio access technology on the first transceiver.

14. The method of claim 13,
wherein the shortened reacquisition procedure is shorter than a standard reacquisition procedure based on a processing performed as part of the use of the diversity receiver to communicate using the second radio access technology.

15. The method of claim 14,
wherein the processing performed as part of the use of the diversity receiver to communicate using the second radio access technology comprises a public land mobile network (PLMN) search for the second radio access technology.

16. The method of claim 1, further comprising:
skipping a public land mobile network (PLMN) search as part of a reacquisition process for the second radio access technology on the first transceiver performed after termination of the communication using the first radio access technology on the first transceiver.

17. The method of claim 16, further comprising:
performing a PLMN search for the second radio access technology as part of the use of the diversity receiver to provide communication using the second radio access technology.

18. The method of claim 17, further comprising:
using, as part of the reacquisition process for the second radio access technology on the first transceiver, results of the PLMN search for the second radio access technology performed as part of the use of the diversity receiver to provide communication using the second radio access technology.

19. The method of claim 1, further comprising:
communicating using the second radio access technology on the first transceiver prior to communicating using the first radio access technology on the first transceiver; and
suspending the communication using the second radio access technology on the first transceiver in order to allow the communication using the first radio access technology on the first transceiver.

20. A user equipment (UE) apparatus comprising:
a first transceiver configured to communicate using a first radio access technology; and
a diversity receiver configured to provide spatial diversity for the communication using the first radio access technology,
wherein the diversity receiver is configured to stop the providing of spatial diversity for the communication using the first radio access technology, and
wherein the diversity receiver is configured to start communication using a second radio access technology, wherein the communication using the first radio access technology continues on the first transceiver.

21. The UE apparatus of claim 20,
wherein the first radio access technology is different from the second radio access technology.

22. The UE apparatus of claim 20, further comprising:
a processor configured to determine when the diversity receiver will start communication using the second radio access technology based on an expected availability of a shared modem resource that is shared between the first transceiver and a second transceiver.

23. The UE apparatus of claim 20,
wherein the diversity receiver is configured to perform a public land mobile access network (PLMN) search for the second radio access technology as part of the communication using the second radio access technology.

24. The UE apparatus of claim 20,
wherein the first transceiver is configured to perform a shortened reacquisition for the second radio access technology.

25. The UE apparatus of claim 24,
wherein the shortened reacquisition procedure is shorter than a standard reacquisition procedure based on a processing performed by the diversity receiver as part of the communication using the second radio access technology.

26. The UE apparatus of claim 25,
wherein the processing performed by the diversity receiver as part of the communication using the second radio access technology comprises a public land mobile network (PLMN) search for the second radio access technology.

27. The UE apparatus of claim 20,
wherein the first transceiver is configured to skip a public land mobile network (PLMN) search as part of a reacquisition process for the second radio access technology after termination of the communication by the first transceiver using the first radio access technology.

28. A non-transitory computer-readable medium, the medium comprising instructions configured to cause one or more computing devices to:
communicate using a first radio access technology on a first transceiver;
use a diversity receiver to provide spatial diversity for the communication using the first radio access technology;
stop the use of the diversity receiver to provide spatial diversity for the communication using the first radio access technology; and
start use of the diversity receiver to communicate using a second radio access technology, wherein the communication using the first radio access technology continues on the first transceiver.

29. A user equipment (UE) apparatus comprising:
means for communicating using a first radio access technology on a first transceiver;
means for using a diversity receiver to provide spatial diversity for the communication using the first radio access technology;
means for stopping the use of the diversity receiver to provide spatial diversity for the communication using the first radio access technology; and
means for starting use of the diversity receiver to communicate using a second radio access technology, wherein the communication using the first radio access technology continues on the first transceiver.
